(19) United States
(12) Patent Application Publication
(10) Pub. No.: US 2025/0175969 A1
(43) Pub. Date: May 29, 2025

(54) ELECTRONIC DEVICE AND METHOD FOR TRANSMITTING TRANSMISSION SIGNAL IN ELECTRONIC DEVICE

(71) Applicant: Samsung Electronics Co., Ltd., Suwon-si (KR)

(72) Inventors: Jeongsik KIM, Suwon-si (KR); Kwangpyo HONG, Suwon-si (KR)

(21) Appl. No.: 18/960,669

(22) Filed: Nov. 26, 2024

Related U.S. Application Data
(63) Continuation of application No. PCT/KR2024/018887, filed on Nov. 26, 2024.

(30) Foreign Application Priority Data
Nov. 27, 2023 (KR) 10-2023-0166402
Jan. 3, 2024 (KR) 10-2024-0000712

(51) Int. Cl. H04W 72/044; H04W 72/0453

(52) U.S. Cl. CPC H04W 72/0473; H04W 72/0453

(57) ABSTRACT

An electronic device is provided. The electronic device includes a plurality of antennas, a radio frequency (RF) circuit including an amplifier configured to amplify an RF signal and a switching circuit configured to selectively connect the amplifier to at least one antenna among the plurality of antennas, memory storing one or more computer programs, and one or more processors electrically connected to the memory and the RF circuit, wherein the one or more computer programs include computer-executable instructions, when executed by the one or more processors individually or collectively, cause the electronic device to identify a first power of a first transmission signal corresponding to a first frequency band, transmitted through the RF circuit, and, based on identifying that the first power is greater than or equal to a set second power, control the switching circuit so that the first transmission signal is simultaneously transmitted through at least two antennas among the plurality of antennas at a transmission time of the first transmission signal.

### CROSS-REFERENCE TO RELATED APPLICATION(S)

This application is a continuation application, claiming priority under § 365 (c), of an International application No. PCT/KR2024/018887, filed on Nov. 26, 2024, which is based on and claims the benefit of a Korean patent application number 10-2023-0166402, filed on Nov. 27, 2023, in the Korean Intellectual Property Office, and of a Korean patent application number 10-2024-0000712, filed on Jan. 3, 2024, in the Korean Intellectual Property Office, the disclosure of each of which is incorporated by reference herein in its entirety.

### TECHNICAL FIELD

The disclosure relates to an electronic device and a method for transmitting a transmission signal in the electronic device.

### BACKGROUND ART

As mobile communication technology evolves, multi-functional portable terminals are commonplace and, to meet increasing demand for radio traffic, vigorous efforts are underway to develop fifth generation (5G) communication systems. To achieve a higher data transmission rate, 5G communication systems are being implemented on higher frequency bands (e.g., a band of 25 GHz to 60 GHz) as well as those used for third generation (3G) communication systems and long-term evolution (LTE) communication systems.

For example, to mitigate pathloss on the millimeter wave (mmWave) band and increase the reach of radio waves, the following techniques are taken into account for the 5G communication system beamforming, massive multi-input multi-output (MIMO), full dimensional MIMO (FD-MIMO), array antenna, analog beamforming, and large-scale antenna.

To transmit a signal from an electronic device to a communication network (e.g., a base station), data generated from a processor or a communication processor in the electronic device may be signal-processed through a radio frequency integrated circuit (RFIC) and radio frequency front-end (RFFE) circuit and then transmitted to the outside of the electronic device through at least one antenna.

The above information is presented as background information only to assist with an understanding of the disclosure. No determination has been made, and no assertion is made, as to whether any of the above might be applicable as prior art with regard to the disclosure.

### DISCLOSURE OF INVENTION

### Solution to Problems

Aspects of the disclosure are to address at least the above-mentioned problems and/or disadvantages and to provide at least the advantages described below. Accordingly, an aspect of the disclosure is to provide an electronic device and method for transmitting transmission signal in electronic device.

Additional aspects will be set forth in part in the description which follows and, in part, will be apparent from the description, or may be learned by practice of the presented embodiments.

In accordance with an aspect of the disclosure, an electronic device is provided. The electronic device includes a plurality of antennas, a radio frequency (RF) circuit including an amplifier configured to amplify an RF signal and a switching circuit configured to selectively connect the amplifier to at least one antenna among the plurality of antennas, memory storing one or more computer programs, and one or more processors electrically connected to the RF circuit and the memory, wherein the one or more computer programs include computer-executable instructions, when executed by the one or more processors individually or collectively, cause the electronic device to identify a first power of a first transmission signal corresponding to a first frequency band, transmitted through the RF circuit, and based on identifying that the first power is greater than or equal to a set second power, control the switching circuit so that the first transmission signal is simultaneously transmitted through at least two antennas among the plurality of antennas at a transmission time of the first transmission signal.

In accordance with another aspect of the disclosure, a method for operating an electronic device including a plurality of antennas, a radio frequency circuit including an amplifier and a switching circuit, and a processor is provided. The method includes identifying a first power of a first transmission signal corresponding to a first frequency band, transmitted through the RF circuit, and based on identifying that the first power is greater than or equal to a set second power, controlling the switching circuit included in the RF circuit so that the first transmission signal is simultaneously transmitted through at least two antennas among the plurality of antennas at a transmission time of the first transmission signal.

In accordance with another aspect of the disclosure, an electronic device is provided. The electronic device includes memory including one or more storage media and storing instructions, and one or more processors communicatively coupled to the memory, wherein the instructions, when executed by the one or more processors individually or collectively, cause the electronic device to identify a first power of a first transmission signal corresponding to a first frequency band, and, based on identifying that the first power of the first transmission signal is greater than or equal to a set second power, simultaneously transmit the first transmission signal through at least two antennas among a plurality of antennas at a transmission time of the first transmission signal.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include identifying a first power of a first transmission signal corresponding to a first frequency band, and, based on identifying that the first power of the first transmission signal is greater than or equal to a set second power, simultaneously transmitting the first transmission signal through at least two antennas among a plurality of antennas at a transmission time of the first transmission signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to an embodiment of the disclosure;

FIG. 2A is a block diagram illustrating an electronic device for supporting legacy network communication and 5G network communication according to an embodiment of the disclosure;

FIG. 2B is a block diagram illustrating an electronic device for supporting legacy network communication and 5G network communication according to an embodiment of the disclosure;

FIG. 2C is a block diagram illustrating an electronic device for supporting legacy network communication and 5G network communication according to an embodiment of the disclosure;

FIG. 3A is a view illustrating wireless communication systems providing a legacy communication network and/or a 5G communication network according to an embodiment of the disclosure;

FIG. 3B is a view illustrating wireless communication systems providing a legacy communication network and/or a 5G communication network according to an embodiment of the disclosure;

FIG. 3C is a view illustrating wireless communication systems providing a legacy communication network and/or a 5G communication network according to an embodiment of the disclosure;

FIG. 4A is a block diagram illustrating an electronic device according to an embodiment of the disclosure;

FIG. 4B is a block diagram illustrating an electronic device according to an embodiments of the disclosure;

FIG. 4C is a block diagram illustrating an electronic device according to an embodiment of the disclosure;

FIG. 5A is a view illustrating transmission of a reference signal by an electronic device according to an embodiment of the disclosure;

FIG. 5B is a view illustrating transmission of a reference signal by an electronic device according to an embodiment of the disclosure;

FIG. 6 is a flowchart illustrating a signal transmission/reception procedure between an electronic device and a communication network according to an embodiment of the disclosure;

FIG. 7 is a view illustrating a transmission period of a reference signal according to an embodiment of the disclosure;

FIG. 8 is a block diagram illustrating a structure of an electronic device according to an embodiment of the disclosure;

FIG. 9 is a view illustrating an antenna of an electronic device according to an embodiment of the disclosure;

FIG. 10 is a block diagram illustrating an electronic device according to an embodiment of the disclosure;

FIG. 11 is a block diagram illustrating an electronic device according to an embodiment of the disclosure;

FIG. 12 is a block diagram illustrating an example of a method for determining maximum transmittable power according to an embodiment of the disclosure;

FIG. 13 illustrates a beam pattern of an antenna according to an embodiment of the disclosure;

FIG. 14 is a graph illustrating performance deterioration of an electronic device according to an embodiment of the disclosure;

FIG. 15 is a circuit diagram illustrating a detailed circuit of an electronic device according to an embodiment of the disclosure;

FIG. 16 is a circuit diagram illustrating a detailed circuit of an electronic device according to an embodiment of the disclosure;

FIG. 17A is a circuit diagram illustrating a detailed circuit of an electronic device according to an embodiment of the disclosure;

FIG. 17B is a circuit diagram illustrating a detailed circuit of an electronic device according to an embodiment of the disclosure;

FIG. 17C is a circuit diagram illustrating a detailed circuit of an electronic device according to an embodiment of the disclosure;

FIG. 17D is a circuit diagram illustrating a detailed circuit of an electronic device according to an embodiment of the disclosure;

FIG. 17E is a circuit diagram illustrating a detailed circuit of an electronic device according to an embodiment of the disclosure;

FIG. 18 is a flowchart illustrating a method for operating an electronic device according to an embodiment of the disclosure;

FIG. 19 is a flowchart illustrating a method for operating an electronic device according to an embodiment of the disclosure;

FIG. 20A is a graph illustrating vertical output of an antenna, according to an embodiment of the disclosure;

FIG. 20B is a graph illustrating horizontal output of an antenna, according to an embodiment of the disclosure;

FIG. 21A is a graph illustrating vertical output of an antenna, according to an embodiment of the disclosure;

FIG. 21B is a graph illustrating horizontal output of an antenna, according to an embodiment of the disclosure;

FIG. 22A is a graph illustrating vertical output of an antenna, according to an embodiment of the disclosure; and

FIG. 22B is a graph illustrating horizontal output of an antenna, according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

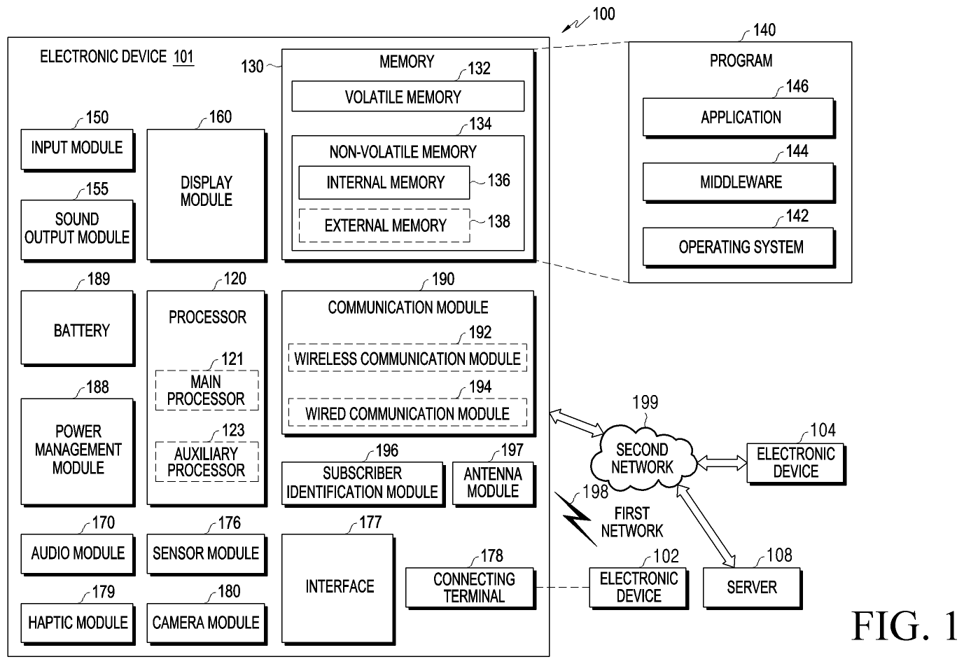

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other components (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all, or some of operations to be executed at the electronic device 101 may be executed at one or more of the external electronic devices 102 or 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

In the following description, the components easy to understand from the description of the above embodiments are denoted with or without the same reference numerals and their detailed description may be skipped. According to an embodiment of the disclosure, an electronic device may be implemented by selectively combining configurations of different embodiments, and the configuration of one embodiment may be replaced by the configuration of another embodiment. However, it is noted that the disclosure is not limited to a specific drawing or embodiment.

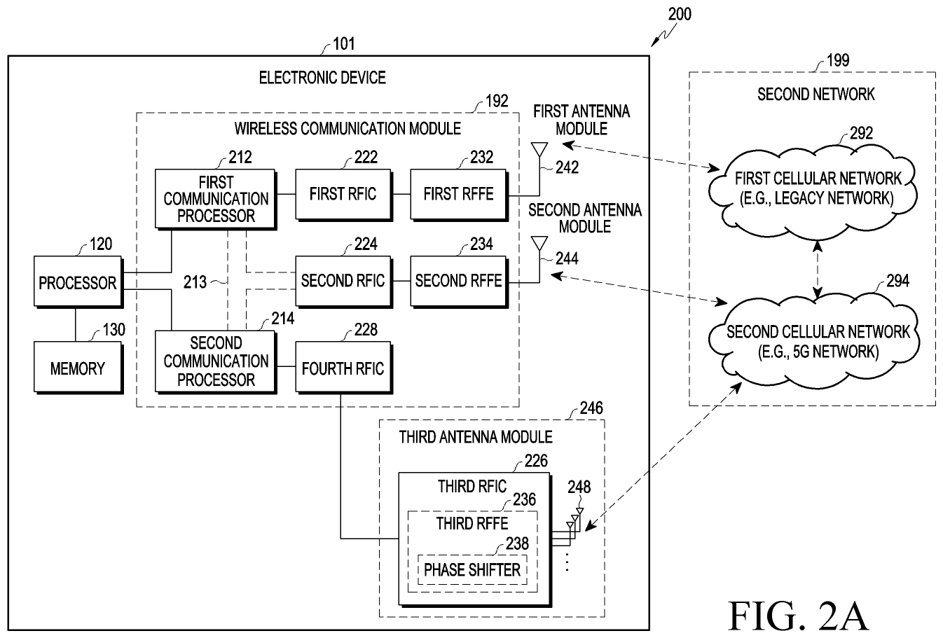

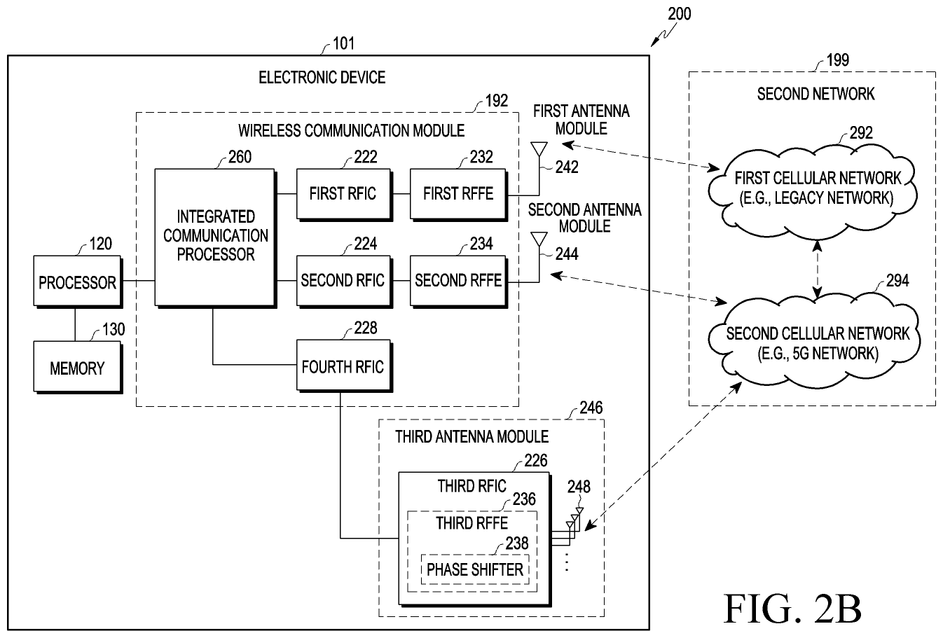

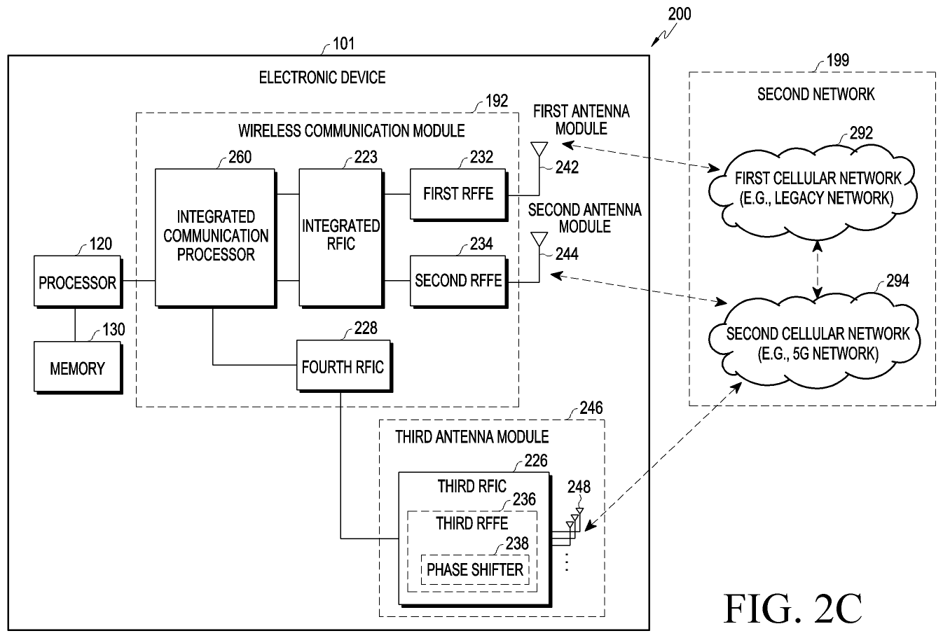

FIG. 2A is a block diagram 200 illustrating an electronic device 101 for supporting legacy network communication and 5G network communication according to an embodiment of the disclosure.

Referring to FIG. 2A, the electronic device 101 may include a first communication processor (CP) 212, a second communication processor 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, a third antenna module 246, and antennas 248. The electronic device 101 may further include a processor 120 and memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first CP 212, the second CP 214, the first RFIC 222, the second RFIC 224, the fourth RFIC 228, the first RFFE 232, and the second RFFE 234 may form at least part of the wireless communication module 192. According to another embodiment, the fourth RFIC 228 may be omitted or be included as part of the third RFIC 226.

The first CP 212 may establish a communication channel of a band that is to be used for wireless communication with the first cellular network 292 or may support legacy network communication via the established communication channel. According to various embodiments, the first cellular network may be a legacy network that includes second generation (2G), third generation (3G), fourth generation (4G), or long-term evolution (LTE) networks. The second CP 214 may establish communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first CP 212 or the second CP 214 may establish a communication channel corresponding to another designated band (e.g., about 6 GHz or less) among the bands that are to be used for wireless communication with the second cellular network 294 or may support fifth generation (5G) network communication via the established communication channel.

The first CP 212 may perform data transmission/reception with the second CP 214. For example, data classified as transmitted via the second cellular network 294 may be changed to be transmitted via the first cellular network 292. In this case, the first CP 212 may receive transmission data from the second CP 214. For example, the first CP 212 may transmit/receive data to/from the second CP 214 via an inter-processor interface 213. The inter-processor interface 213 may be implemented as, e.g., universal asynchronous receiver/transmitter (UART) (e.g., high speed-UART (HS-UART)) or peripheral component interconnect bus express (PCIe) interface, but is not limited to a specific kind. The first CP 212 and the second CP 214 may exchange packet data information and control information using, e.g., a shared memory. The first CP 212 may transmit/receive various types of information, such as sensing information, information about output strength, and resource block (RB) allocation information, to/from the second CP 214.

According to implementation, the first CP 212 may not be directly connected with the second CP 214. In this case, the first CP 212 may transmit/receive data to/from the second CP 214 via a processor 120 (e.g., an application processor). For example, the first CP 212 and the second CP 214 may transmit/receive data to/from the processor 120 (e.g., an application processor) via an HS-UART interface or PCIe interface, but the kind of the interface is not limited thereto. The first CP 212 and the second CP 214 may exchange control information and packet data information with the processor 120 (e.g., an application processor) using a shared memory.

FIG. 2B is a block diagram illustrating an electronic device for supporting legacy network communication and 5G network communication according to an embodiment of the disclosure.

According to an embodiment, the first CP 212 and the second CP 214 may be implemented in a single chip or a single package. According to an embodiment, the first CP 212 or the second CP 214, along with the processor 120, an auxiliary processor 123, or communication module 190, may be formed in a single chip or single package. For example, referring to FIG. 2B, an integrated CP 260 may support all of the functions for communication with the first cellular network 292 and the second cellular network 294.

Upon transmission, the first RFIC 222 may convert a baseband signal generated by the first CP 212 into a radio frequency (RF) signal with a frequency ranging from about 700 MHz to about 3 GHz which is used by the first cellular network 292 (e.g., a legacy network). Upon receipt, the RF signal may be obtained from the first network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first CP 212.

Upon transmission, the second RFIC 224 may convert the baseband signal generated by the first CP 212 or the second CP 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first CP 212 and the second CP 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second CP 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second CP 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second CP 214.

FIG. 2C is a block diagram illustrating an electronic device for supporting legacy network communication and 5G network communication according to an embodiment of the disclosure.

According to an embodiment, the first RFIC 222 and the second RFIC 224 may be implemented as at least part of a single chip or single package. According to various embodiments, when the first RFIC 222 and the second RFIC 224 in FIG. 2A or 2B are implemented as a single chip or a single package, they may be implemented as an integrated RFIC 223 as shown in FIG. 2C. In this case, the integrated RFIC 223 may be connected to the first RFFE 232 and the second RFFE 234, and the integrated RFIC 223 may convert a baseband signal into a signal of a band supported by the first RFFE 232 and/or the second RFFE 234 and may transmit the converted signal to one of the first RFFE 232 and the second RFFE 234. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub-PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of high-frequency band (e.g., from about 6 GHz to about 60 GHz) signal used for 5G network communication due to the transmission line. Thus, the electronic device 101 may enhance the communication quality with the second network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may have the access network (e.g., 5G radio access network (RAN) or next generation RAN (NG RAN)) but may not have the core network (e.g., next generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 130 and be accessed by other components (e.g., the processor 120, the first CP 212, or the second CP 214).

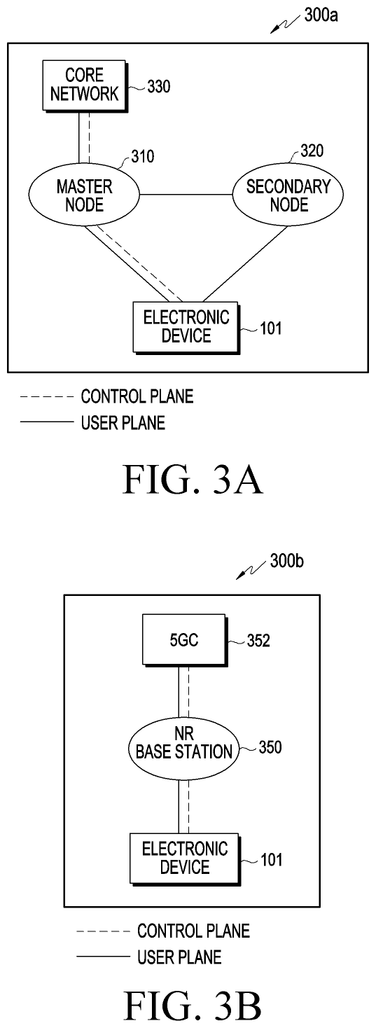

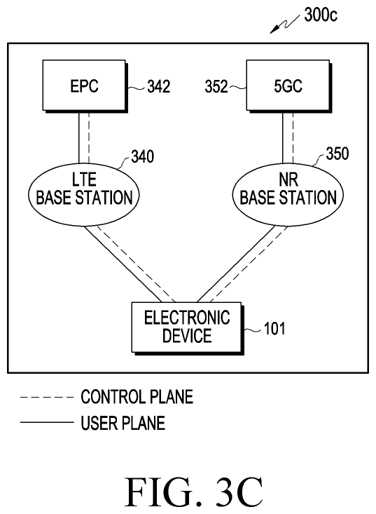

FIGS. 3A, 3B, and 3C are views illustrating wireless communication systems providing legacy communication and/or 5G communication networks according to various embodiments of the disclosure.

Referring to FIGS. 3A, 3B, and 3C, the network environment 300a, 300b, and 300c may include at least one of a legacy network and a 5G network. The legacy network may include, e.g., a 3GPP-standard 4G or LTE base station 340 (e.g., an eNodeB (eNB)) that supports radio access with the electronic device 101 and an evolved packet core (EPC) 342 that manages 4G communication. The 5G network may include, e.g., a new radio (NR) base station 350 (e.g., a gNodeB (gNB)) that supports radio access with the electronic device 101 and a 5th generation core (5GC) 352 that manages 5G communication for the electronic device 101.

According to various embodiments, the electronic device 101 may transmit or receive control messages and user data via legacy communication and/or 5G communication. The control messages may include messages related to at least one of, e.g., security control, bearer setup, authentication, enrollment, or mobility management of the electronic device 101. The user data may mean, e.g., user data except for control messages transmitted or received between the electronic device 101 and the core network 330 (e.g., the EPC 342).

Referring to FIG. 3A, according to an embodiment, the electronic device 101 may transmit or receive at least one of a control message or user data to/from at least part (e.g., the NR base station 350 or 5GC 352) of the 5G network via at least part (e.g., the LTE base station 340 or EPC 342) of the legacy network.

According to various embodiments, the network environment 300a may include a network environment that provides wireless communication dual connectivity (DC) to the LTE base station 340 and the NR base station 350 and transmits or receives control messages to/from the electronic device 101 via one core network 230 of the EPC 342 or the 5GC 352.

According various embodiments, in the DC environment, one of the LTE base station 340 or the NR base station 350 may operate as a master node (MN) 310, and the other as a secondary node (SN) 320. The MN 310 may be connected to the core network 230 to transmit and receive control messages. The MN 310 and the SN 320 may be connected with each other via a network interface to transmit or receive messages related to radio resource (e.g., communication channel) management therebetween.

According to an embodiment, the MN 310 may include the LTE base station 340, the SN 320 may include the NR base station 350, and the core network 330 may include the EPC 342. For example, control messages may be transmitted/received via the LTE base station 340 and the EPC 342, and user data may be transmitted/received via at least one of the LTE base station 340 or the NR base station 350.

According to various embodiments, the MN 310 may include the NR base station 350, the SN 320 may include the LTE base station 340, and the core network 330 may include the 5GC 352. For example, control messages may be transmitted/received via the NR base station 350 and the 5GC 352, and user data may be transmitted/received via at least one of the LTE base station 340 or the NR base station 350.

Referring to FIG. 3B, according to various embodiments, the 5G network may include the NR base station 350 and the 5GC 352 and transmit/receive control messages and user data independently from the electronic device 101.

Referring to FIG. 3C, according to an embodiment, the legacy network and the 5G network each may provide data transmission/reception independently. For example, the electronic device 101 and the EPC 342 may transmit/receive control messages and user data through the LTE base station 340. As another example, the electronic device 101 and the 5GC 352 may transmit/receive control messages and user data through the NR base station 350.

According to an embodiment, the electronic device 101 may be registered in at least one of the EPC 342 or the 5GC 352 to transmit or receive control messages.

According to an embodiment, the EPC 342 or the 5GC 352 may interwork with each other to manage communication for the electronic device 101. For example, mobility information for the electronic device 101 may be transmitted or received via the interface between the EPC 342 and the 5GC 352.

As set forth above, dual connectivity via the LTE base station 340 and the NR base station 350 may be referred to as E-UTRA new radio dual connectivity (EN-DC).

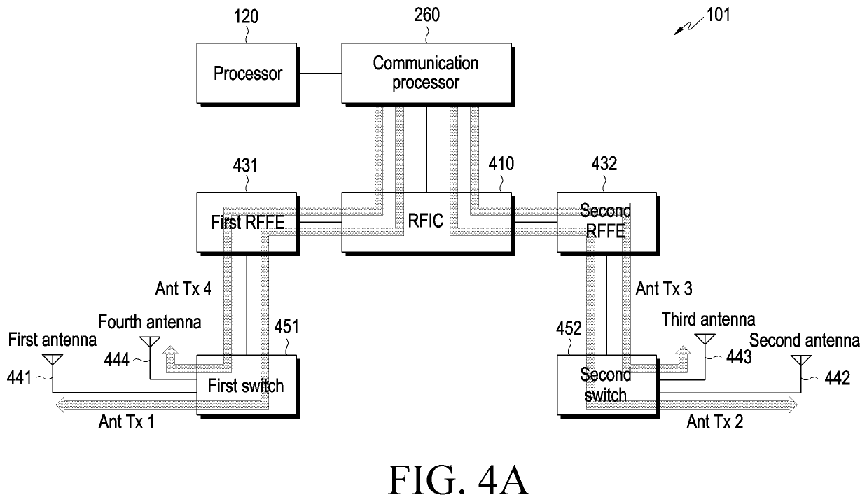

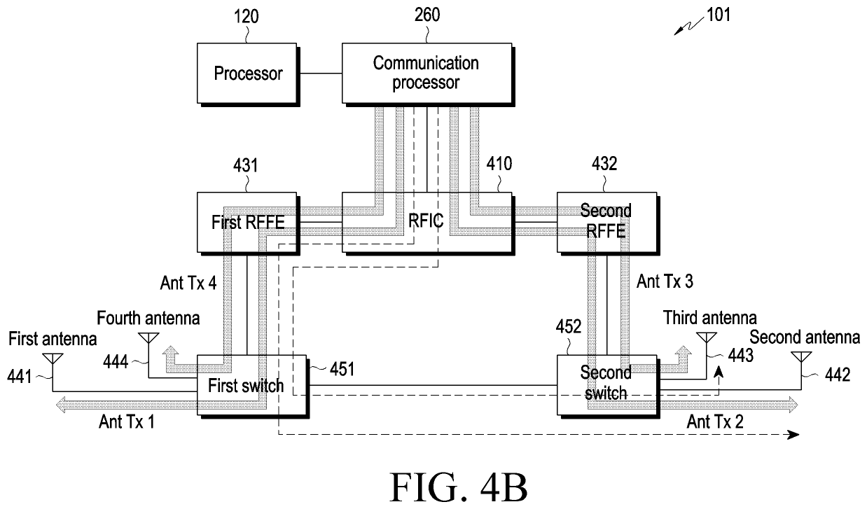

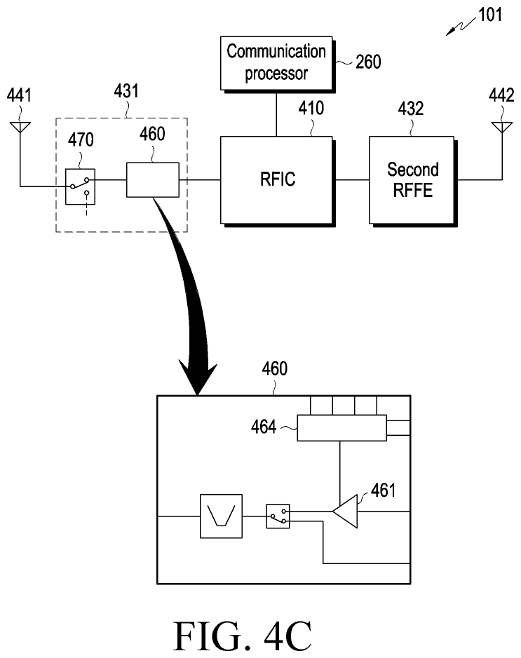

Hereinafter, the structure of the electronic device 101 according to various embodiments is described in detail with reference to FIGS. 4A, 4B, 4C, 5A, 5B, 6, 7, 8, 9, and 10. Although each drawing of the embodiments described below illustrates that one communication processor 260 and one RFIC 410 are connected to a plurality of RFFEs 431 and 432, various embodiments described below are not limited thereto. For example, in various embodiments described below, as illustrated in FIG. 2A or FIG. 2B, a plurality of CPs 212 and 214 and/or a plurality of RFICs 222, 224, 226, and 228 may be connected to a plurality of RFFEs 431 and 432.

FIGS. 4A and 4B are block diagrams illustrating electronic devices according to various embodiments of the disclosure.

Referring to FIG. 4A, according to various embodiments, an electronic device (e.g., the electronic device 101 of FIG. 1) may include a processor 120, a communication processor 260, an RFIC 410, a first RFFE 431, a second RFFE 432, a first antenna 441, a second antenna 442, a third antenna 443, a fourth antenna 444, a first switch 451, or a second switch 452. For example, the first RFFE 431 may be disposed at an upper portion in the housing of the electronic device 101, and the second RFFE 432 may be disposed at a lower portion in the housing of the electronic device 101 than the first RFFE 431. However, various embodiments of the disclosure are not limited to the placement positions.

According to various embodiments, upon transmission, the RFIC 410 may convert a baseband signal generated by the communication processor 260 into a radio frequency (RF) signal used in the first communication network or the second communication network. For example, the RFIC 410 may transmit an RF signal used in the first communication network to the first antenna 441 or the fourth antenna 444 through the first RFFE 431 and the first switch 451. The RFIC 410 may transmits an RF signal used in the first communication network or the second communication network to the second antenna 442 or the third antenna 443 through the second RFFE 432 and the second switch 452. According to various embodiments, the RFIC 410 may transmit an RF signal corresponding to the first communication network (e.g., NR) to the first antenna 441 or the fourth antenna 444 through the first RFFE 431 and may transmit an RF signal corresponding to the second communication network (e.g., LTE) to the second antenna 442 or the third antenna 443 through the second RFFE 432. According to another embodiment, the RFIC 410 may operate as a multi-input multi-output (MIMO) antenna by transmitting an RF signal corresponding to the first communication network (e.g., NR) or the second communication network (e.g., LTE) to the first antenna 441 or the fourth antenna 444 through the first RFFE 431 and transmitting an RF signal corresponding to the same first communication network (e.g., NR) or second communication network (e.g., LTE) to the second antenna 442 or the third antenna 443 through the second RFFE 432.

According to various embodiments, the transmission path of transmission from the RFIC 410 to the first antenna 441 through the first RFFE 431 and the first switch 451 may be referred to as a ‘first antenna transmission path (Ant Tx 1)’. The transmission path of transmission from the RFIC 410 to the fourth antenna 444 through the first RFFE 431 and the first switch 451 may be referred to as a ‘fourth antenna transmission path (Ant Tx 4)’.

According to various embodiments, upon transmission, the RFIC 410 may convert a baseband signal generated by the communication processor 260 into a radio frequency (RF) signal used in the first communication network or the second communication network. For example, the RFIC 410 may transmit an RF signal used in the first communication network or the second communication network to the second antenna 442 or the third antenna 443 through the second RFFE 432 and the second switch 452.

According to various embodiments, the transmission path of transmission from the RFIC 410 to the second antenna 442 through the second RFFE 432 and the second switch 452 may be referred to as a ‘second antenna transmission path (Ant Tx 2)’. The transmission path of transmission from the RFIC 410 to the third antenna 443 through the second RFFE 432 and the second switch 452 may be referred to as a ‘third antenna transmission path (Ant Tx 3)’.

According to various embodiments, during reception, the RF signal may be received from the first communication network through the first antenna 441 or the fourth antenna 444, and the received RF signal may be transmitted to the communication processor 260 through at least one RFIC. Further, the RF signal may be received from the first communication network or the second communication network through the second antenna 442 or the third antenna 443, and the received RF signal may be transmitted to the communication processor 260 through at least one RFIC.

According to various embodiments, the first communication network and the second communication network may be communication networks different from each other. For example, the first communication network may be a 5G network, and the second communication network may be a legacy network (e.g., an LTE network). When the first communication network is a 5G network, the first RFFE 431 may be designed to be suitable for processing signals corresponding to the 5G network, and the second RFFE 432 may be designed to be suitable for processing signals corresponding to the legacy network.

According to various embodiments, a frequency band of a signal transmitted through the first RFFE 431 and a frequency band of a signal transmitted through the second RFFE 432 may be the same, similar, or different. For example, the frequency band of the signal transmitted through the first RFFE 431 may be the N48 band or the N78 band (3.5 GHZ), which is the frequency band of the 5G network, and may be the B48 band (3.5 GHZ), which is the frequency band of the LTE network. The frequency band of the signal transmitted through the second RFFE 432 may be the B48 band (3.5 GHZ), which is the frequency band of the LTE network. In this case, although the first RFFE 431 and the second RFFE 432 process the same or similar frequency band signals, the first RFFE 431 may be designed to be able to process signals suitable for the characteristics of the 5G network, and the second RFFE 432 may be designed to be able to process signals suitable for the characteristics of the LTE network.

According to various embodiments, when the electronic device transmits a signal through any one of the first antenna 441 and the fourth antenna 444 through the first RFFE 431 and the first switch 451 and transmits a reference signal through the first antenna 441 and the fourth antenna 444, it may be referred to as ‘1T2R’ because it uses one transmission antenna Tx and two reception antennas Rx. According to various embodiments, when the electronic device transmits a signal through any one of the second antenna 442 and the third antenna 443 through the second RFFE 432 and the second switch 452 and transmits a reference signal through the second antenna 442 and the third antenna 443, it may be referred to as ‘1T2R’ because it uses one transmission antenna Tx and two reception antennas Rx.

According to various embodiments, when the electronic device simultaneously transmits and receives data through the first RFFE 431 and the second RFFE 432, it may be referred to as ‘2T4R’ because it uses two transmission antennas Tx and four reception antennas Rx. Since the electronic device illustrated in FIG. 4A may operate as 1T2R or 2T4R according to various embodiments, the electronic device may be referred to as an electronic device supporting ‘1T2R/2T4R’.

According to various embodiments, the communication processor 260 may perform control to transmit a reference signal (e.g., a sounding reference signal (SRS)) referenced for channel estimation by the base station of the first communication network to at least one antenna (the first antenna 441 or the fourth antenna 444) among the plurality of antennas of the first antenna group through the first RFFE circuit 431. According to various embodiments, the communication processor 260 may perform control to additionally transmit the reference signal referenced for channel estimation by the base station of the first communication network to at least one antenna (the second antenna 442 or the third antenna 443) among the plurality of antennas of the second antenna group through the second RFFE circuit 432. When the electronic device transmits the reference signal through the first antenna 441, the second antenna 442, the third antenna 443, and the fourth antenna 444, a base station of the first communication network may receive the reference signal and may perform channel estimation through the received reference signal. The base station of the first communication network may transmit a signal beamformed for the first antenna 441, the second antenna 442, the third antenna 443, and the fourth antenna 444. The electronic device may receive the signal transmitted from the base station of the first communication network through the first antenna 441, the second antenna 442, the third antenna 443, and the fourth antenna 444. The electronic device illustrated in FIG. 4A is designed as an electronic device supporting ‘1T2R/2T4R’, but according to various embodiments, the electronic device may operate as ‘1T4R’ by transmitting a reference signal to the base station of the first communication network through the first antenna 441, the second antenna 442, the third antenna 443, and the fourth antenna 444.

Referring to FIG. 4B, an electronic device (e.g., the electronic device 101 of FIG. 1) according to various embodiments may include a processor 120, a communication processor 260, an RFIC 410, a first RFFE 431, a second RFFE 432, a first antenna 441, a second antenna 442, a third antenna 443, a fourth antenna 444, a first switch 451, or a second switch 452. For example, the first RFFE 431 may be disposed at an upper portion in the housing of the electronic device 101, and the second RFFE 432 may be disposed at a lower portion in the housing of the electronic device 101 than the first RFFE 431. However, various embodiments of the disclosure are not limited to the placement positions. In the embodiment of FIG. 4B to be described below, descriptions applicable in common to FIG. 4A described above are omitted.

According to various embodiments, upon transmission, the RFIC 410 may convert a baseband signal generated by the communication processor 260 into a radio frequency (RF) signal used in the first communication network or the second communication network. For example, the RFIC 410 may transmit an RF signal used in the first communication network to the first antenna 441 or the fourth antenna 444 through the first RFFE 431 and the first switch 451. Further, the RFIC 410 may transmit an RF signal used in the first communication network to the second antenna 442 or the third antenna 443 through the first RFFE 431, the first switch 451, and the second switch 452.

According to various embodiments, the RFIC 410 may transmit an RF signal corresponding to the first communication network (e.g., NR) to the first antenna 441 or the fourth antenna 444 through the first RFFE 431 and may transmit an RF signal corresponding to the second communication network (e.g., LTE) to the second antenna 442 or the third antenna 443 through the second RFFE 432. According to various embodiments, the RFIC 410 may operate as a multi-input multi-output (MIMO) antenna by transmitting an RF signal corresponding to the first communication network (e.g., NR) or the second communication network (e.g., LTE) to the first antenna 441 or the fourth antenna 444 through the first RFFE 431 and the first switch 451 and transmitting the RF signal to the second antenna 442 or the third antenna 443 through the first RFFE 431, the first switch 451, and the second switch 452. According to various embodiments, the transmission path of transmission from the RFIC 410 to the first antenna 441 through the first RFFE 431 and the first switch 451 may be referred to as a ‘first antenna transmission path (Ant Tx 1)’. The transmission path of transmission from the RFIC 410 to the fourth antenna 444 through the first RFFE 431 and the first switch 451 may be referred to as a ‘fourth antenna transmission path (Ant Tx 4)’. The transmission path of transmission from the RFIC 410 to the second antenna 442 through the first RFFE 431, the first switch 451, and the second switch 452 may be referred to as a ‘second antenna transmission path (Ant Tx 2)’. The transmission path of transmission from the RFIC 410 to the third antenna 443 through the first RFFE 431, the first switch 451, and the second switch 452 may be referred to as a ‘third antenna transmission path (Ant Tx 3)’.

FIG. 4C is a block diagram illustrating in detail an electronic device according to an embodiment of the disclosure.

Referring to FIG. 4C, according to various embodiments, an electronic device (e.g., the electronic device 101 of FIG. 1) may include a communication processor 260, an RFIC 410, a first RFFE 431, a first antenna 441, a second RFFE 432, and a second antenna 442.

According to various embodiments, the first RFFE 431 may further include additional components different from the second RFFE 432, for signal processing suitable for the characteristics of the 5G network or for supporting multiple bands. For example, the first RFFE 431 may include a front end module (FEM) 460 and a first single pole double throw (SPDT) switch 470.

According to various embodiments, the FEM 460 may include an amplifier (e.g., a power amplifier (PA) 461) and a PA ET (envelop tracking IC) 464. According to various embodiments, the PA ET IC 464 may be included in the FEM 460 or may be connected with the FEM 460 outside the FEM 460 as illustrated in FIG. 4C. The PA ET IC 464 may control the Vcc of the PA 461 according to the control of the communication processor 260 or the RFIC 410. The PA envelop tracking IC (ET IC) 464 may operate in a plurality of modes (e.g., an envelope tracking (ET) mode, an average power tracking (APT) mode, and a maximum power mode (e.g., APT full bias or battery direct)) according to the control of the communication processor 260 or the RFIC 410.

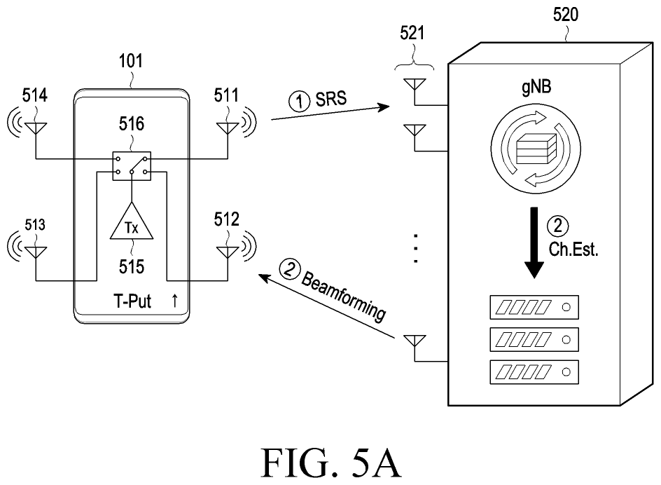

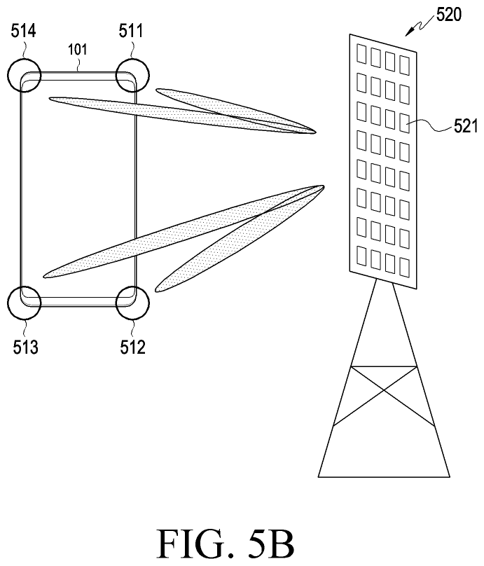

FIGS. 5A and 5B are views illustrating transmission of a reference signal by an electronic device according to various embodiments of the disclosure.

Referring to FIG. 5A, an electronic device 101 (e.g., the electronic device 101 of FIG. 1) may transmit a reference signal (e.g., an SRS) through four antennas (e.g., a first antenna 511, a second antenna 512, a third antenna 513, and a fourth antenna 514). For example, the electronic device 101 may amplify the reference signal through at least one power amplifier (PA) 515 and may transmit the amplified reference signal to the first antenna 511, the second antenna 512, the third antenna 513, and the fourth antenna 514 through at least one switch 516. The reference signal (e.g., an SRS) transmitted through each antenna (e.g., the first antenna 511, the second antenna 512, the third antenna 513, and the fourth antenna 514) of the electronic device 101 may be received through each antenna 521 of a base station 520 (e.g., a gNB).

According to various embodiments, the base station 520 may receive the reference signal transmitted from the electronic device 101 and may estimate the channel (channel estimation) for each antenna (e.g., the first antenna 511, the second antenna 512, the third antenna 513, and the fourth antenna 514) of the electronic device 101 from the received reference signal. The base station 520 may transmit a beamformed signal to each antenna of the electronic device 101 based on the channel estimation.

Although FIG. 5A illustrates one power amplifier 515 and one switch 516 connected with a plurality of antennas (a first antenna 511, a second antenna 512, a third antenna 513, and a fourth antenna 514) for ease of description, it will readily be appreciated by one of ordinary skill in the art that embodiments of the disclosure are not limited thereto. As an example, the electronic device 101 may further include components included in the electronic device 101 shown in FIG. 4A or 4B.

Referring to FIG. 5B, the base station 520 may transmit the beamformed signal through an array antenna 521 including a plurality of (e.g., 32) antennas. The signal transmitted from the base station 520 may be received through each antenna (e.g., the first antenna 511, the second antenna 512, the third antenna 513, and the fourth antenna 514) of the electronic device 101 and, as shown in FIG. 5B, a signal in a beam shape directed by the beamforming of the base station 520 may be received by each antenna (e.g., the first antenna 511, the second antenna 512, the third antenna 513, and the fourth antenna 514) of the electronic device 101.

As illustrated in FIGS. 5A and 5B, if the electronic device 101 transmits a reference signal (e.g., an SRS) through a plurality of transmission paths, the base station 520 may identify the channel environment with each antenna (e.g., the first antenna 511, the second antenna 512, the third antenna 513, and the fourth antenna 514)) of the electronic device 101 and perform beamforming, enhancing the reference signal received power (RSRP) and/or signal to noise ratio (SNR) of the downlink channel. If the RSRP and/or SNR of the downlink channel is enhanced, the rank index (RI) or channel quality indicator (CQI) for the electronic device may be increased. The base station 520 allocates a high rank or modulation and code schemes (MCS) to the electronic device 101 based on the enhanced performance of the electronic device 101 so that the downlink throughput of the electronic device 101 may be enhanced.

According to various embodiments, the base station 520 may use a downlink reference signal for downlink channel estimation. For example, if the base station 520 transmits the downlink reference signal to the electronic device 101, the electronic device 101 may receive the downlink reference signal transmitted from the base station 520 and perform channel estimation. The electronic device 101 may transmit the result of channel estimation to the base station 520, and the base station 520 may perform downlink beamforming with reference to the result of the channel estimation transmitted from the electronic device 101. According to various embodiments, when the base station 520 performs channel estimation by the reference signal (e.g., an SRS) transmitted from the electronic device 101, channel estimation may be performed faster than the channel estimation by the downlink reference signal,

According to various embodiments, a first communication network (e.g., a base station (gNB)) or a second communication network (e.g., a base station (gNB)) may send a request for various configuration information for the electronic device 101 by transmitting a UE capability enquiry message to the electronic device 101. For example, a first communication network (e.g., a base station (gNB)) or a second communication network (e.g., a base station (eNB)) may send a request for information related to the reception antenna of the electronic device 101 through the UE capability enquiry message. The electronic device 101 may receive the UE capability enquiry message from the first communication network or the second communication network and, in response thereto, may transmit a UE capability information message to the first communication network or the second communication network. According to various embodiments, information related to the reception antenna of the electronic device 101, such as ‘supportedSRS-TxPortSwitch tlr4,’ may be included in the UE capability information message, according to the content of the UE capability enquiry message.

As the antenna-related information is specified as ‘supportedSRS-TxPortSwitch tlr4’, the first communication network may determine that the electronic device 101 may transmit signals using four reception antennas and transmit an RRC reconfiguration message including information for the time of transmission of a reference signal (e.g., an SRS) for each of the four antennas.

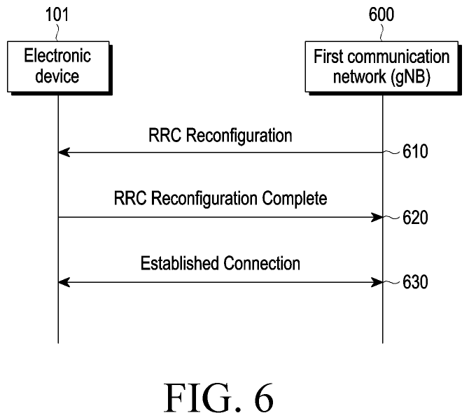

FIG. 6 is a flowchart illustrating a signal transmission/reception procedure between an electronic device and a communication network according to an embodiment of the disclosure.

Referring to FIG. 6, an electronic device 101 may establish an RRC connection with a first communication network 600 (e.g., a base station (gNB)) through a random-access channel (RACH) procedure.

According to various embodiments, in operation 610, the first communication network 600 may transmit an RRC reconfiguration message to the electronic device 101. For example, the first communication network 600 may transmit an RRC reconfiguration message in response to the RRC request message transmitted by the electronic device 101. As described above, the RRC reconfiguration message may include information regarding a time point at which the electronic device 101 transmits a reference signal (e.g., an SRS) through each antenna as shown in Table 1 below.

TABLE 1

perodicityAndOffset-p s120: 17
perodicityAndOffset-p s120: 7
perodicityAndOffset-p s120: 13
perodicityAndOffset-p s120: 3
nrofSymbols n1

Referring to the RRC reconfiguration message, as specified as “nrofSymbols n1.”, the duration of SRS transmission may be determined as an allocated symbol. According to an embodiment, referring to the RRC reconfiguration message, as specified as “periodicity AndOffset-p s120: 17”, the first SRS may be set to be transmit in the 17th slot while being transmitted once every 20 slots. As specified as “periodicityAndOffset-p s120: 7”, the second SRS may be set to be transmitted in the 7th slot while being transmitted once every 20 slots. As specified as “periodicityAndOffset-p s120: 13”, the third SRS is transmitted in the 13th slot while being transmitted once every 20 slots. As specified as “periodicity AndOffset-p s120: 3”, the fourth SRS may be set to be transmit in the 3rd slot while being transmitted once every 20 slots.

According to various embodiments, the electronic device 101 may transmit four SRSs at different times through the respective antennas every 20 slots according to the configuration of RRC reconfiguration. The size of one slot may be determined by the subcarrier spacing (SCS). For example, when the SCS is 30 KHz, the time interval of one slot may be 0.5 ms, and the time interval of 20 slots may be 10 ms. Accordingly, the electronic device 101 may repeatedly transmit the SRS at different times through the respective antennas every 10 ms. According to various embodiments, one slot may include 14 symbols and, assuming that one symbol is allocated for one SRS transmission, it may have a symbol duration (or symbol enable time) of 0.5 ms*1/14=35 μs (0.035 ms).

According to various embodiments, in operation 620, the electronic device 101 may transmit an RRC reconfiguration complete message to the first communication network 600. As the RRC reconfiguration procedure is normally completed, in operation 630, the electronic device 101 and the first communication network 600 may complete RRC connection establishment.

Referring back to FIGS. 4A and 4B, according to various embodiments, the communication processor 260 and/or the RFIC 410 may transmit a reference signal at a different time for each time period (e.g., 10 ms) set through each antenna transmission path (e.g., a first antenna transmission path, a second antenna transmission path, a third antenna transmission path, and a fourth antenna transmission path) based on the information about the transmission time of the reference signal (e.g., SRS) received from the first communication network 600 as described above.

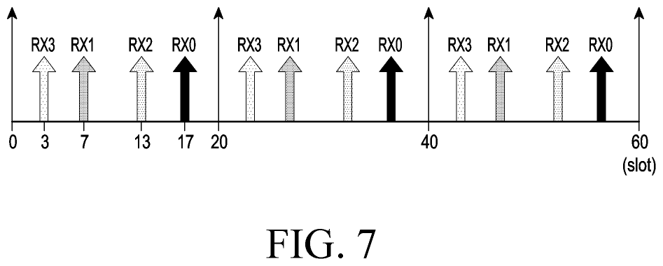

FIG. 7 is a view illustrating a transmission period of a reference signal according to an embodiment of the disclosure.

Referring to FIG. 7, every 10 ms, the electronic device may transmit the first SRS through the first antenna 441 (RX0) in the 17th slot among the 20 slots, transmit the second SRS through the second antenna 442 (RX1) in the 7th slot, transmit the third SRS through the third antenna 443 (RX2) in the 13th slot, and transmit the fourth SRS through the fourth antenna 444 (RX3) in the third slot.

According to various embodiments, the reference signal may be a sounding reference signal (SRS) used for multi-antenna signal processing (e.g., multi-input multi output (MIMO) or beamforming) through uplink channel state measurement, but embodiments of the disclosure are not limited thereto.

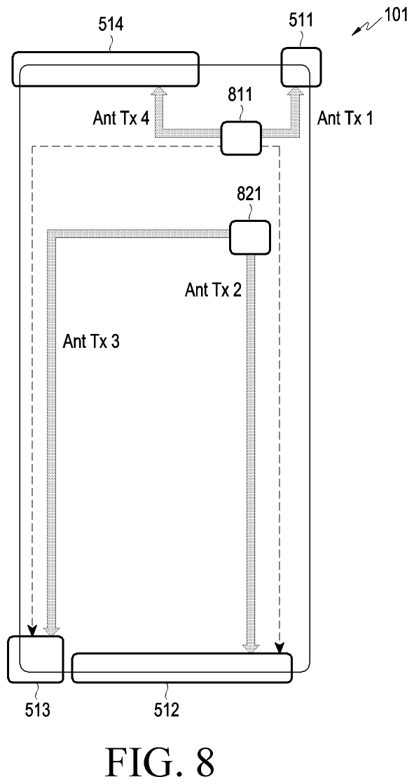

FIG. 8 is a block diagram illustrating a structure of an electronic device according to an embodiment of the disclosure.

Referring to FIG. 8, the electronic device 101 may transmit a first transmission signal or an SRS through the first RFFE 811 and each antenna (the first antenna 511, the second antenna 512, the third antenna 513, and the fourth antenna 514). For example, the electronic device 101 may transmit the first transmission signal to the first antenna 511 or may transmit the first transmission signal to the fourth antenna 514 through the first RFFE 811. The electronic device 101 may transmit the first transmission signal to the second antenna 512 or may transmit the first transmission signal to the third antenna 513 through the first RFFE 811. The electronic device 101 may transmit an SRS to the second antenna 512 or the third antenna 513 through the first RFFE 811. The electronic device 101 may transmit the second transmission signal through the second RFFE 821 and each antenna (the first antenna 511, the second antenna 512, the third antenna 513, and the fourth antenna 514).

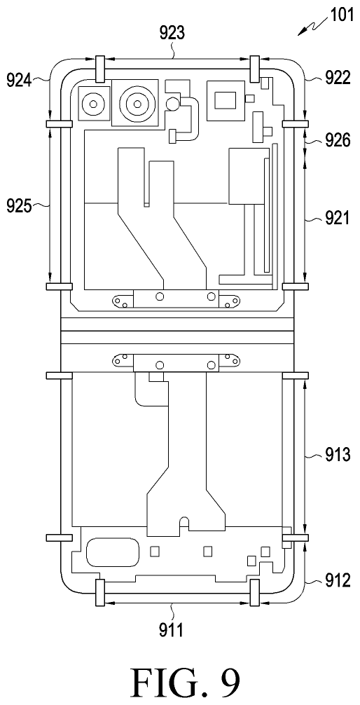

FIG. 9 is a view illustrating an antenna of an electronic device according to an embodiment of the disclosure.

Referring to FIG. 9, according to an embodiment, an electronic device 101 may include a plurality of antennas. For example, the electronic device 101 may include a first main antenna 911, a second main antenna 912, and a third main antenna 913 as three main antennas in the lower body. The first main antenna 911 may process signals in a frequency band corresponding to a low band (LB) and a mid-band (MB). The third main antenna 913 may process signals in a frequency band corresponding to a mid-band MB and a high band HB.

According to an embodiment, the electronic device 101 may include a first sub antenna 921, a second sub antenna 922, a third sub antenna 923, a fourth sub antenna 924, a fifth sub antenna 925, and a sixth sub antenna 926 as six sub antennas in the upper body. The first sub antenna 921 may process signals in a frequency band corresponding to a high band HB or a low band LB. The second sub antenna 922 may process signals in a frequency band corresponding to a high band HB and a Wi-Fi signal. The third sub antenna 923 may process signals in a frequency band corresponding to a mid-band MB. The fourth sub antenna 924 may process a global positioning system (GPS) signal and a Wi-Fi signal. The fifth sub antenna 925 may process signals in a frequency band corresponding to the mid-band MB. In the above, frequency bands corresponding to the low band LB, the mid band MB, and the high band HB may be variously set by the operator. According to an embodiment, within a frequency band of 300 MHz to 300 GHZ, a band of 1 GHz or less may be classified as a low band (LB), a band of 1 GHz to 6 GHz may be classified as a mid-band (MB), and a band of 6 GHz or more may be classified as a high band (HB), but this is merely an example and embodiments are not limited thereto. For example, the high band HB may be referred to as a frequency of 3.5 GHz or more.

According to an embodiment, a first transmission signal (e.g., a signal of the B48, N48, or N78 band) corresponding to the first frequency band (e.g., the frequency band of 3.5 GHz) may be configured to be amplified to a set magnitude through the first RFFE 811 and then transmitted through the second sub antenna 922. According to an embodiment, the first transmission signal corresponding to the first frequency band may be configured to be amplified to a set magnitude through the first RFFE 811 and then transmitted through the first sub antenna 921.

According to an embodiment, the SRS signal may be configured to be amplified to a set magnitude through the first RFFE 811 and then transmitted through the fifth sub antenna 925. According to an embodiment, the SRS signal may be configured to be amplified to a set magnitude through the first RFFE 811 and then transmitted through the third main antenna 913.

The RFFE and the antenna to which each of the above-described signals is transmitted have been described as an example, and the first transmission signal or SRS may be transmitted through a combination of various RFFEs and antennas.

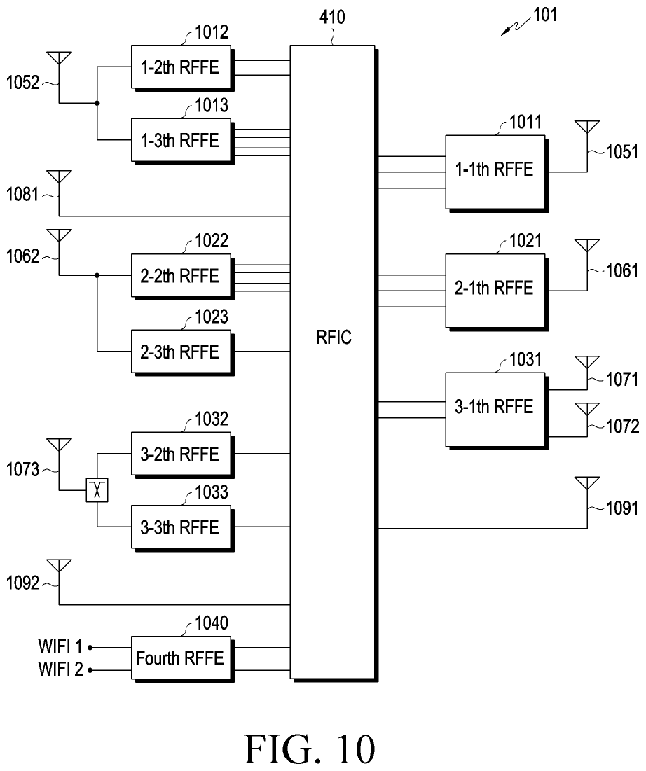

FIG. 10 is a block diagram illustrating an electronic device according to an embodiment of the disclosure.

Referring to FIG. 10, a plurality of RFFEs 1011, 1012, 1013, 1021, 1022, 1023, 1031, 1032, 1033, and 1040 may be connected to at least one RFIC 410. The plurality of RFFEs 1011, 1012, 1013, 1021, 1022, 1023, 1031, 1032, 1033, and 1040 may be connected to a plurality of antennas 1051, 1052, 1061, 1062, 1071, 1072, 1073, 1081, 1091, and 1092.

According to various embodiments, a 1-1th RFFE 1011 and a 2-1th RFFE 1021 may be connected with a first main antenna 1051 and a second main antenna 1061, respectively. A 1-2th RFFE 1012 and a 1-3th RFFE 1013 may be connected with a first sub antenna 1052 to provide diversity with the first main antenna 1051. A 2-2th RFFE 1022 and a 2-3th RFFE 1023 may be connected with a second sub antenna 1062 to provide diversity with the second main antenna 1061. A 3-1th RFFE 1031 may be connected with two third main antennas 1071 and 1072 to provide MIMO. Further, a 3-2th RFFE 1032 and a 3-3th RFFE 1033 may be connected with a third sub antenna 1073 through a duplexer to provide MIMO or diversity with the third main antennas 1071 and 1072. A fifth antenna 1081 may be directly connected to the RFIC 410 without passing through an RFFE. A 6-1th antenna 1091 and a 6-2th antenna 1092 may also be directly connected to the RFIC 410 without passing through a RFFE and may provide MIMO or diversity through two antennas. The fourth RFFE 1040 may be connected to two Wi-Fi antennas (e.g., Wi-Fi 1 and Wi-Fi 2).

According to various embodiments, at least one of the RFFEs of FIG. 10 may correspond to any one of the first RFFE 431 and the second RFFE 432 described above with reference to FIGS. 4A, 4B, 4C, and 9. At least one of the antennas of FIG. 10 may correspond to any one of the first antenna 441, the second antenna 442, the third antenna 443, and the fourth antenna 444 described above with reference to FIGS. 4A, 4B, and 4C. At least one of the antennas of FIG. 10 may correspond to any one of the first main antenna 911, the second main antenna 912, and the third main antenna 913 described with reference to FIG. 9. At least one of the antennas of FIG. 10 may correspond to any one of the first sub antenna 921, the second sub antenna 922, the third sub antenna 923, the fourth sub antenna 924, the fifth sub antenna 925, and the sixth sub antenna 926 described above with reference to FIG. 9.

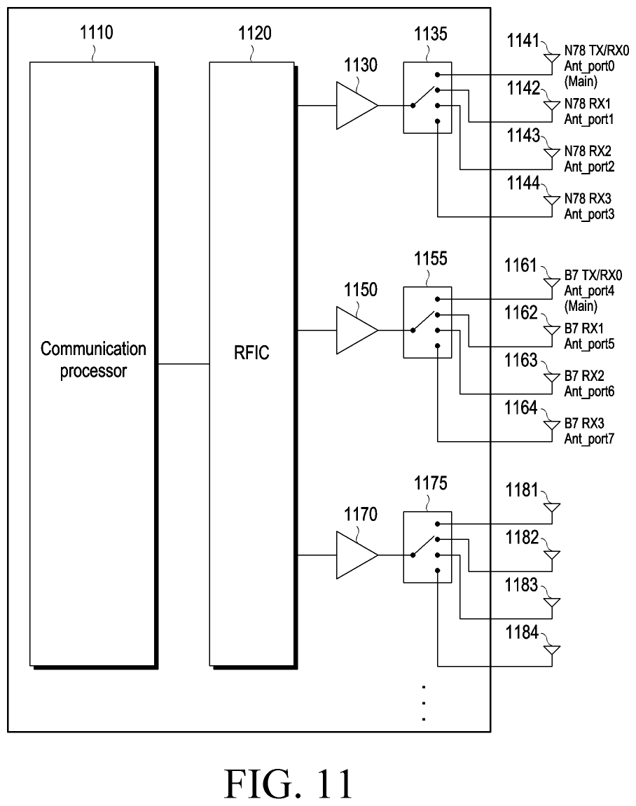

FIG. 11 is a block diagram illustrating an electronic device according to an embodiment of the disclosure.

According to various embodiments, an electronic device 101 may include a communication processor 1110 (e.g., at least one of the first communication processor 212, the second communication processor 214, or the integrated communication processor 260) and an RFIC 1120 (e.g., at least one of the first RFIC 222, the second RFIC 224, the third RFIC 226, or the fourth RFIC 228).

According to an embodiment, the electronic device 101 may include at least one of at least one amplifier 1130, 1150, or 1170 (e.g., a power amplifier (PA)), at least one switch 1135, 1155, or 1175 (e.g., a switching circuit or a switch box), or at least one antenna 1141, 1142, 1143, 1144, 1161, 1162, 1163, 1164, 1181, 1182, 1183, or 1184. For convenience of description, although FIG. 11 illustrates that elements for RF signal transmission are included in the electronic device 101, it will be easily appreciated by one of ordinary skill in the art that elements for receiving and/or processing RF signals may further be included in the electronic device 101.

According to an embodiment, each amplifier and each switch may be included in one integrated circuit IC or may be configured as separate integrated circuits. For example, the first amplifier 1130 and the first switch 1135 may be configured as one first module (e.g., a first power amplifier module (PAM)). The second amplifier 1150 and the second switch 1155 may be configured as one second module (e.g., a second PAM). The third amplifier 1170 and the third switch 1175 may be configured as one third module (e.g., a third PAM).

According to various embodiments, the communication processor 1110 may support a plurality of RATs (e.g., LTE communication and NR communication). In the communication processor 1110, protocol stacks (e.g., a 3GPP protocol stack for LTE communication and a 3GPP protocol stack for NR communication) for the plurality of RATs may be defined (or stored). The protocol stack may receive a data packet (or Internet protocol (IP) packet) from the application processor (e.g., the processor 120) (or the transmission control protocol (TCP)/IP stack) and process and output it. If the RF signal received from the outside is converted into a baseband signal and received, the protocol stack may process the baseband signal and provide it to the application processor (e.g., the processor 120 (or TCP/IP stack)). The protocol stack may perform an operation for signaling (e.g., control).

According to various embodiments, the RF IC 1120 may process the signal (e.g., a baseband signal) received from the communication processor 1110 and output an RF signal. The RFIC 1120 may be referred to as a transceiver, but is not limited by the term. The at least one amplifier 1130, 1150, and 1170 may amplify and provide the received RF signal. As the at least one amplifier 1130, 1150, and 1170 is controlled, the output power of the RF signal may be adjusted. According to an embodiment, the SRS of NR communication may be transmitted through each of the first antenna 1141, the second antenna 1142, the third antenna 1143, and the fourth antenna 1144. For example, the electronic device 101 may support 1T4R. The first antenna 1141 may be an antenna capable of performing both transmission and reception, and the second antenna 1142, the third antenna 1143, and the fourth antenna 1144 may be antennas for reception. The communication processor 1110 may identify the power of the transmission signal and may control the amplifier 1130 so that the identified power of transmission signal is applied to the port for each antenna. The first switch 1135 may selectively connect the RFIC 1120 and the antenna so that the RF signal is applied to a designated antenna. For example, in the example of FIG. 11, a signal in the N78 frequency band is illustrated as being transmitted, but a signal in the N77 or B48 frequency band may be transmitted, and the frequency band is not limited thereto. It will be understood by one of ordinary skill in the art that the number of antennas 1141, 1142, 1143, and 1144 for NR communication is exemplary and is not limited thereto.

According to various embodiments, the electronic device 101 may support carrier aggregation (CA) for LTE. For example, in the embodiment of FIG. 11, the frequency band of B7 associated with the primary cell (PCell) may be selected, and at least one frequency band (not shown) associated with the secondary cell (SCell) may be selected. The number of component carriers (CCs) for CA is not limited to a specific one. However, depending on hardware (HW) restrictions and the frequency band operated by the operator, 2 or more and 32 or less CCs may be typically operated. The signal associated with the PCell may be transmitted/received via at least one of the antennas 1161, 1162, 1163, and 1164 via the second amplifier 1150 and/or the second switch 1155. The signal associated with the SCell may be transmitted/received via at least one of the antennas 1181, 1182, 1183, and 1184, via the third amplifier 1170 and/or the third switch 1175. The numbers of antennas 1161, 1162, 1163, and 1164 and antennas 1181, 1182, 1183, and 1184 are also exemplary. According to various embodiments, a plurality of frequency bands may correspond to one antenna. For example, the antennas 1161, 1162, 1163, and 1164 may correspond to ultra-high bands (e.g., N78 and N79) as well as high bands (e.g., frequency bands 7, 38, 39, 40, and 41). Accordingly, it will be easily appreciated by one of ordinary skill in the art that the number of antennas may be smaller than that of FIG. 11.

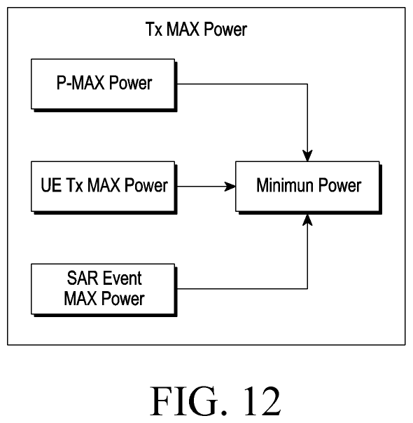

FIG. 12 is a block diagram illustrating an example of a method for determining maximum transmittable power according to an embodiment of the disclosure.

Referring to FIG. 12, according to various embodiments, the maximum transmittable power (Tx Max Power) for each transmission path may be set considering at least one of the maximum transmittable power (P-MAX power (PeMax) received from each communication network (e.g., a base station), the maximum transmittable power (UE Tx MAX power (PcMax)) for each transmission path set by the electronic device 101, or an SAR event maximum transmittable power (SAR EVENT MAX power) set corresponding to each SAR event considering the specific absorption rate (SAR) backoff. For example, the maximum transmittable power (Tx Max Power) may be determined as a minimum value among the plurality of the above exemplified maximum transmittable powers (e.g., P-MAX power, UE Tx MAX power, and SAR EVENT MAX power), but is not limited thereto. According to various embodiments, the maximum transmittable power of the SAR event may be set to differ according to each SAR event (e.g., a grip event or a proximity event).

According to various embodiments, the maximum transmittable power (P-MAX power) (PeMax) received from the communication network (e.g., a base station) may be set to differ according to the power class (PC) supportable by each communication network or electronic device. For example, when the power class is PC2, it may be determined as a value (e.g., 27 dBm) within a range set with respect to 26 dBm, and it may be determined as a value (e.g., 24 dBm) within a range set with respect to 23 dBm when the power class is PC3. According to various embodiments, the maximum transmittable power (UE Tx MAX power, PcMax) for each transmission path set in the electronic device 101 may differ as the RFFE for each transmission path is different, and it may also differ as the length of each transmission path is different.

In embodiments described below, the power of the transmission signal may be configured not to exceed the maximum transmittable power (Tx Max Power). According to an embodiment, the power of the transmission signal is power output from an amplifier (e.g., the amplifier 1130, 1150, or 1170 of FIG. 11), and may correspond to the power of the signal supplied to each antenna (e.g., the antenna 1141, 1142, 1143, 1144, 1161, 1162, 1163, 1164, 1181, 1182, 1183, or 1184 of FIG. 11). For example, the power of the transmission signal may also be referred to as conduction power or target power, but is not limited thereto.

According to an embodiment, the power (e.g., the conduction power or the target power) of the transmission signal may be changed according to the channel state that is changed in real time, and may be determined according to transmission power control (TPC) by the base station. For example, the electronic device 101 may determine the power of the transmission signal based on Equation 1 below according to the standard document 3GPP TS 38.213.

$$Equation 1$$

$${P}_{O\_PUSCH , b , f , c} ( j ) + 10 {log}_{10} ( \text{?} \cdot {M}_{RB , b , f , c}^{PUSCH} ( i ) ) \text{?} ( j ) \cdot \text{?} ( \text{?} ) + \text{?} ( i ) + \text{?} ( i , \text{?} )$$

$$\text{?} \text{indicates text missing or illegible when filed}$$

The definition of Equation 1 may follow 3GPP TS 38.213, and for example, P_{O_PUSCH,b,f,c(j)} may be provided by p0 for the activated uplink bandwidth part (UL BWP) b of the carrier f of the serving cell c. M^{PUSCH}_{RB,b,f,c(i)} is the bandwidth represented as the number of the resource block for the transmission occasion i on the activated UL BWP b of the carrier f of the serving cell c, and μ is the subcarrier spacing (SCS). α_{b,f,c(j)} may be provided by alpha for the activated UL BWP of the carrier f of the serving cell c. PL_{b,f,c}(q_{d}) is the downlink path loss predicted in dB by the user equipment (UE) using the RS resource index q_{d} for the activated downlink BWP (DL BWP) of the serving cell c. f_{b,f,c}(i) may follow 3GPP TS 38.213 and may be adjusted by downlink control information (DCI) transmitted from the base station to the electronic device.

According to various embodiments, the electronic device 101 may determine the power of the transmission signal determined based on Equation 1 within a range not exceeding the maximum transmittable power (Tx Max Power) described above. For example, if the maximum transmittable power of the electronic device is set to 21 dBm and the power of the transmission signal determined based on Equation 1 is 22 dBm, the transmission power for transmission of uplink data (e.g., PUSCH data) in the electronic device 101 may be limited to 21 dBm.

FIG. 13 illustrates a beam pattern of an antenna according to an embodiment of the disclosure.

Referring to FIG. 13, each antenna 1301 (e.g., the antennas 911, 912, 913, 921, 922, 923, 924, 925, and 926 of FIG. 9) included in the electronic device 101 may have a specific beam pattern. As the antenna 1301 has the specific beam pattern, an antenna gain may be generated.

According to an embodiment, assuming that the antenna 1301 is an isotropic antenna, the beam pattern 1311 of the isotropic antenna may have a circular shape as illustrated. When the antenna 1301 is a dipole antenna, beam patterns 1312a and 1312b of the dipole antenna may have two elliptical shapes as illustrated. When the antenna 1301 is a directional antenna in a specific direction, the beam patterns 1313a and 1313b of the directional antenna may be sharper in the specific direction as illustrated. Referring to FIG. 13, it may be assumed that the antenna gain of the dipole antenna for the isotropic antenna is 2.15 dB. Further, the antenna gain of the directional antenna for the dipole antenna may be expressed in dBd, and the antenna gain of the directional antenna for the isotropic antenna may be expressed in dBi.

According to an embodiment, the effective isotropical radiated power (EIRP) may be expressed as the product of the power Pt (e.g., the conduction power or the target power) of the transmission signal supplied to the antenna 1301 and the absolute gain Ga of the isotropic antenna as shown in Equation 2 below.

$$EIRP = Pt \times Ga \qquad Equation 2$$

According to an embodiment, referring to Equation 2, assuming that the antenna gain for the isotropic antenna is 10 dBd and the power of the transmission signal is 30 dBm (e.g., 1 W), the effective radiated power (ERP), which is the power output from the isotropic antenna, may be calculated as 40 dBm (e.g., 10 W) as shown in Equation 3 below.

$$ERP = 10 dBd + 30 dBm = 40 dBm \qquad Equation 3$$

In Equation 3, assuming that the antenna gain for the dipole antenna is 2.15 dB, the EIRP, which is the power output from the dipole antenna, may be calculated as 42.15 dBm (e.g., 16.4 W) as shown in Equation 4 below.

$$ERP = 40 dBm + 2.15 dB = 42.15 dBm \qquad Equation 4$$

According to an embodiment, as illustrated in FIG. 13, even when the power Pt of the transmission signal output from the amplifier (e.g., the power amplifier) to the antenna is less than or equal to the set maximum transmittable power, the power actually output from the antenna by the antenna gain may be relatively greater.

According to an embodiment, for a specific frequency band (e.g., a 3.5 GHz frequency band), the maximum output of the signal output from an antenna may be limited according to various purposes (e.g., protection of a radar work band). Accordingly, even when the power Pt of the transmission signal output to the antenna is less than or equal to the set maximum transmittable power, the maximum output reference limited by the antenna gain may be exceeded. For example, assuming that the maximum output reference for the specific frequency band (e.g., B48, N48, and N78) of the specific group is 23.0 dBm, and that the maximum transmittable power of the transmission signal is 23.0 dBm, the antenna gain may be set to 0 dBi or less to meet the maximum output reference of the specific group. According to an embodiment, when the maximum transmittable power of the transmission signal is 23.0 dBm and the antenna output power of the specific frequency band (e.g., B48, N48, and N78) is 24.0 to 25.0 dBm due to the antenna gain, a situation in which the maximum output reference of the specific group is exceeded may occur. According to an embodiment, in order to meet the maximum output reference (e.g., 23.0 dBm) of the specific group, the maximum transmittable power of the transmission signal may be decreased by 1 dB to be set to 22.0 dBm. As described above, when the maximum transmittable power of the transmission signal is decreased, the maximum output reference of the specific group may be met, but not only the transmission power but also the performance of the reception signal may be deteriorated. For example, as performance deterioration of the reception signal occurs, RF performance deterioration such as call drop and throughput (T-put) performance deterioration in a weak electric field may occur.

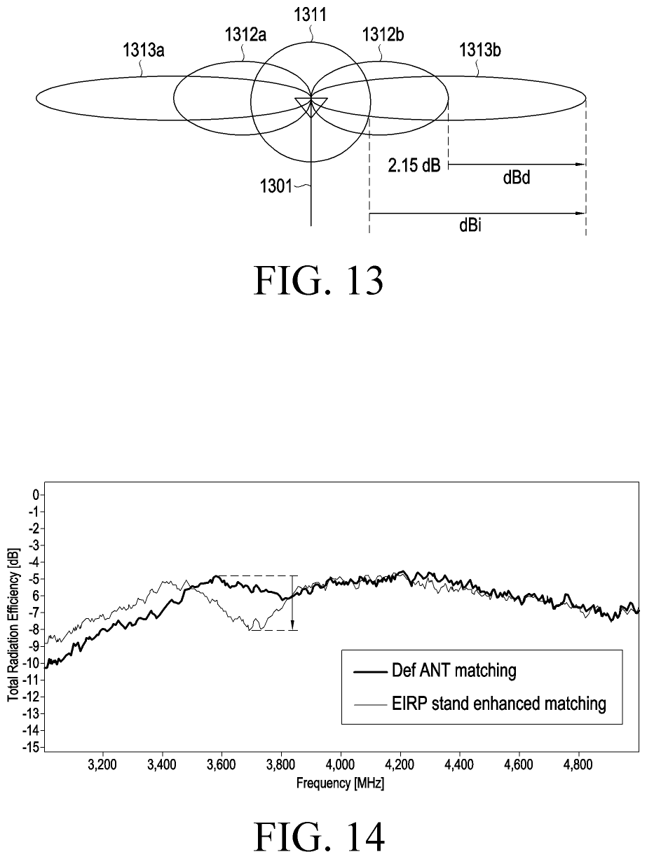

FIG. 14 is a graph illustrating performance deterioration of an electronic device according to an embodiment of the disclosure.

Referring to FIG. 14, antenna gain may be reduced by modifying antenna matching to meet the EIRP standard for frequencies of 3.5 GHz to 3.8 GHz. For example, by modifying antenna matching for the frequency of 3.5 GHz to 3.8 GHz, it is possible to bring about antenna performance deterioration by 2 to 3 dB. For example, as the maximum transmittable power (e.g., the conduction power or the target power) of the transmission signal and the antenna gain are reduced, the EIRP of the corresponding frequency band (e.g., B48, N48, and N78) may be reduced to 21.5 to 22.0 dBm, meeting the corresponding standard. As described above, when the standard is met by reducing the antenna gain together with the maximum transmittable power, the power of the transmission signal in all frequency bands as well as the specific frequency band may be decreased. Further, as the antenna gain is reduced, the reception performance of the antenna may be decreased. The deterioration of the transmission/reception performance may lead to a decrease in the transmission/reception rate and a decrease in the throughput performance in the weak electric field.

Described below are various embodiments capable of meeting the EIRP standard in a specific frequency band without reducing the maximum transmittable power and antenna gain.

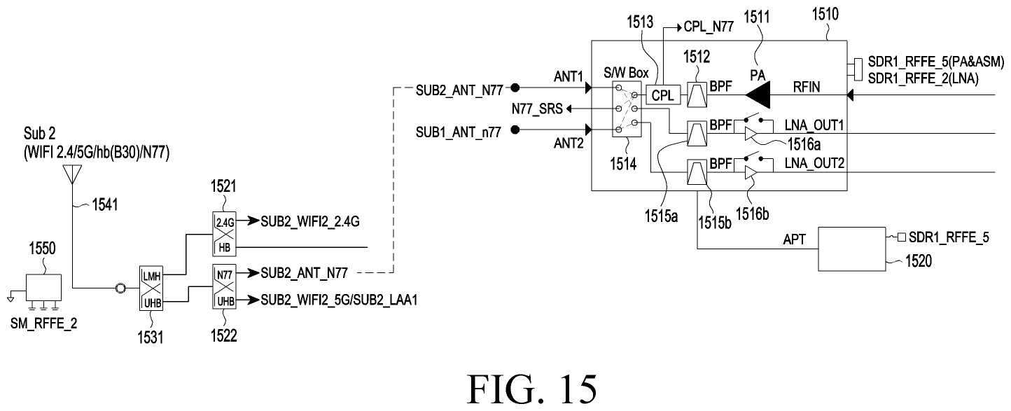

FIG. 15 is a circuit diagram illustrating a detailed circuit of an electronic device according to an embodiment of the disclosure.

Referring to FIG. 15, an electronic device (e.g., the electronic device 101 of FIG. 1) may include an RF circuit 1510, an average power tracking (APT) circuit 1520, diplexers (e.g., the first diplexer 1521, the second diplexer 1522, the third diplexer 1531), an antenna (e.g., the second sub antenna 1541), and an antenna matching circuit 1550. FIG. 15 illustrates a transmission path in which a first transmission signal corresponding to a first frequency band (e.g., N77 or N78) is transmitted through the RF circuit 1510 and the second sub antenna 1541 (e.g., the second sub antenna 922 of FIG. 9), with other components (e.g., other RF circuits or other antennas) of the electronic device 101 omitted.

According to an embodiment, the RF circuit 1510 may include an amplifier 1511 (e.g., a power amplifier (PA)), band pass filters (BPFs) (e.g., a first BPF 1512, a 2-1th BPF 1515a, and a 2-2th BPF 1515b), a coupler 1513, a switching circuit 1514 (e.g., a switch box or an antenna switch module (ASM)), and a low noise amplifier (LNA) (e.g., a 2-1th LNA 1516a and a 2-2th LNA 1516b). According to an embodiment, the RF circuit 1510 may be referred to as an RFFE, a front end module (FEM), a power amplifier module (PAM), a power amplifier module with integrated duplexer (PAMiD), a LNA PAMID (LPAMiD), or a front end module with integrated duplexer (FEMid) depending on the function or the component included therein, but is not limited thereto.

According to an embodiment, as illustrated in FIG. 15, the amplifier 1511 and the switching circuit 1514 may be included in one semiconductor chip or integrated circuit constituting the RF circuit 1510. According to an embodiment, the switching circuit 1514 may be configured as a separate module outside the RF circuit 1510. According to an embodiment, the RF circuit 1510 may be configured as a semiconductor chip integrated with the above-described RF IC 1120 or an integrated circuit. For example, the amplifier 1511 and/or the switching circuit 1514 included in the RF circuit 1510 may be configured as a semiconductor chip integrated with the RFIC 1120 or an integrated circuit.

According to an embodiment, the first transmission signal corresponding to the first frequency band (e.g., N77 or N78) output from the RFIC (e.g., the RFIC 1120 of FIG. 11) may be amplified to the first power (e.g., the conduction power or the target power) through the amplifier 1511 of the RF circuit 1510. The first transmission signal amplified by the amplifier 1511 may be band-filtered through the first BPF 1512 and may be input to the switching circuit 1514 through the coupler 1513. The first transmission signal input to the switching circuit 1514 through the coupler 1513 may be transmitted to the second sub antenna 1541 (e.g., the second sub antenna 922 of FIG. 9) through a first antenna connection terminal ANT1 or may be transmitted to the first sub antenna (e.g., the first sub antenna 921 of FIG. 9) through a second antenna connection terminal ANT2, at the transmission time. For example, the switching circuit 1514 may connect a terminal connected to the coupler 1513 to the first antenna connection terminal ANT1 at the transmission time of the first transmission signal. The first transmission signal may be output through the first antenna connection terminal ANT1 of the switching circuit 1514, and may be transmitted to the second sub antenna 1541 through the second diplexer 1522 and the third diplexer 1531. The switching circuit 1514 may connect the terminal connected to the coupler 1513 to the second antenna connection terminal ANT2 at the transmission time of the first transmission signal. The first transmission signal may be output through the second antenna connection terminal ANT2 of the switching circuit 1514 and may be transmitted to the first sub antenna (e.g., the first sub antenna 921 of FIG. 9).

According to an embodiment, the SRS output from the RFIC (e.g., the RFIC 1120 of FIG. 11) may be amplified to power set for the SRS through the amplifier 1511 of the RF circuit 1510. The SRS amplified by the amplifier 1511 may be band-filtered through the first BPF 1512 and may be input to the switching circuit 1514 through the coupler 1513. The SRS input to the switching circuit 1514 through the coupler 1513 may be transmitted to the third main antenna (e.g., the third main antenna 913 of FIG. 9) or the fifth sub antenna (e.g., the fifth sub antenna 925 of FIG. 9) through an SRS connection terminal N77_SRS at the SRS transmission time.

According to an embodiment, the signal received through the first antenna connection terminal ANT1 or the second antenna connection terminal ANT2 may be filtered through the 2-1th BPF 1515a, amplified through the 2-1th LNA 1516a, and then input to an RFIC (e.g., the RFIC 1120 of FIG. 11). The signal received through the first antenna connection terminal ANT1 or the second antenna connection terminal ANT2 may be filtered through the 2-2th BPF 1515b, amplified through the 2-2th LNA 1516b, and then input to an RFIC (e.g., the RFIC 1120 of FIG. 11).

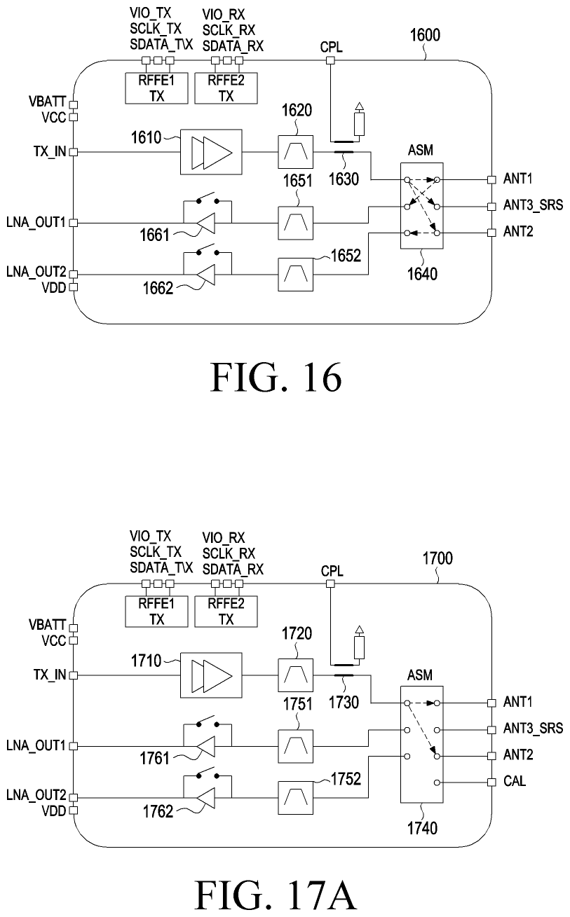

FIG. 16 is a circuit diagram illustrating a detailed circuit of an electronic device according to an embodiment of the disclosure.

Referring to FIG. 16, according to an embodiment, an RF circuit 1600 may include an amplifier 1610 (e.g., a power amplifier (PA)), band pass filters (BPFs) (e.g., a first BPF 1620, a 2-1th BPF 1651, and a 2-2th BPF 1652), a coupler 1630, a switching circuit 1640 (e.g., a switch box or an antenna switch module (ASM)), and a low noise amplifier (LNA) (e.g., a 2-1th LNA 1661 and a 2-2th LNA 1662). According to an embodiment, the RF circuit 1600 may be referred to as an RFFE, a front end module (FEM), a power amplifier module (PAM), a power amplifier module with integrated duplexer (PAMiD), a LNA PAMID (LPAMiD), or a front end module with integrated duplexer (FEMid) depending on the function or the component included therein, but is not limited thereto.

According to an embodiment, as illustrated in FIG. 16, the amplifier 1610 and the switching circuit 1640 may be included in one semiconductor chip or integrated circuit constituting the RF circuit 1600. According to an embodiment, the switching circuit 1640 may be configured as a separate module outside the RF circuit 1600. According to an embodiment, the RF circuit 1600 may be configured as a semiconductor chip integrated with the above-described RF IC 1120 or an integrated circuit. For example, the amplifier 1610 and/or the switching circuit 1640 included in the RF circuit 1600 may be configured as a semiconductor chip integrated with the RFIC 1120 or an integrated circuit.

According to an embodiment, the first transmission signal corresponding to the first frequency band (e.g., N77 or N78) output from the RFIC (e.g., the RFIC 1120 of FIG. 11) may be amplified to the first power (e.g., the conduction power or the target power) through the amplifier 1610 of the RF circuit 1600. The first transmission signal amplified by the amplifier 1610 may be band-filtered through the first BPF 1620 and may be input to the switching circuit 1640 through the coupler 1630. The first transmission signal input to the switching circuit 1640 through the coupler 1630 may be transmitted to the second sub antenna (e.g., the second sub antenna 922 of FIG. 9) through a first antenna connection terminal ANT1 or may be transmitted to the first sub antenna (e.g., the first sub antenna 921 of FIG. 9) through a second antenna connection terminal ANT2, at the transmission time. For example, the switching circuit 1640 may connect a terminal connected to the coupler 1630 to the first antenna connection terminal ANT1 at the transmission time of the first transmission signal. The first transmission signal may be transmitted to the second sub antenna (e.g., the second sub antenna 922 of FIG. 9) through the first antenna connection terminal ANT1 of the switching circuit 1640. The switching circuit 1640 may connect the terminal connected to the coupler 1630 to the second antenna connection terminal ANT2 at the transmission time of the first transmission signal. The first transmission signal may be output through the second antenna connection terminal ANT2 of the switching circuit 1640 and may be transmitted to the first sub antenna (e.g., the first sub antenna 921 of FIG. 9).

According to an embodiment, the SRS output from the RFIC (e.g., the RFIC 1120 of FIG. 11) may be amplified to power set for the SRS through the amplifier 1610 of the RF circuit 1600. The SRS amplified by the amplifier 1610 may be band-filtered through the first BPF 1620 and may be input to the switching circuit 1640 through the coupler 1630. The SRS input to the switching circuit 1640 through the coupler 1630 may be transmitted to the third main antenna (e.g., the third main antenna 913 of FIG. 9) or the fifth sub antenna (e.g., the fifth sub antenna 925 of FIG. 9) through an SRS connection terminal ANT3_SRS at the SRS transmission time. According to an embodiment, the coupler 1630 may be used to sense power of the first transmission signal or SRS. For example, the signal coupled through the coupler 1630 may be fed back to an RFIC (e.g., the RFIC 1120 of FIG. 11) or a communication processor (e.g., the communication processor 1110 of FIG. 11), thereby sensing transmission power.

According to an embodiment, the signal received through the first antenna connection terminal ANT1 or the second antenna connection terminal ANT2 may be filtered through the 2-1th BPF 1651, amplified through the 2-1th LNA 1661, and then input to an RFIC (e.g., the RFIC 1120 of FIG. 11). The signal received through the first antenna connection terminal ANT1 or the second antenna connection terminal ANT2 may be filtered through the 2-2th BPF 1652, amplified through the 2-2th LNA 1662, and then input to an RFIC (e.g., the RFIC 1120 of FIG. 11).

According to an embodiment, the switching circuit 1640 may be controlled by a control signal SW_CTRL of a processor (e.g., the processor 120 or the integrated communication processor 260 of FIG. 2B or FIG. 2C). For example, the switching circuit 1640 may be controlled by a logic table set as shown in Table 2 below.

TABLE 2

| | port |
|---|---|
| SW_CTRL | ANT1 |
| | ANT2 |
| | ANT3_SRS |

According to an embodiment, referring to Table 2, the first transmission signal corresponding to the first frequency band input to the switching circuit 1640 through the coupler 1630 may be transmitted to the ANT1, ANT2, or ANT3_SRS port by the control signal SW_CTRL of the processor (e.g., the processor 120 or the integrated communication processor 260 of FIG. 2B or FIG. 2C). For example, when the control signal SW_CTRL is a signal corresponding to ANT1, the first transmission signal may be transmitted to a second sub antenna (e.g., the second sub antenna 922 of FIG. 9) through the ANT1 port. When the control signal SW_CTRL is a signal corresponding to ANT2, the first transmission signal may be transmitted to a first sub antenna (e.g., the first sub antenna 921 of FIG. 9) through the ANT2 port. When the control signal SW_CTRL is a signal corresponding to ANT3_SRS, the SRS may be transmitted to a third main antenna (e.g., the third main antenna 913 of FIG. 9) or a fifth sub antenna (e.g., the fifth sub antenna 925 of FIG. 9) through the ANT3_SRS port.

According to an embodiment, as described above with reference to FIG. 13, even when the first power (e.g., the conduction power or the target power) of the first transmission signal corresponding to the first frequency band output from the amplifier 1610 is less than or equal to the set maximum transmittable power, the power actually output from the antenna may be greater than the first power by the antenna gain.

According to an embodiment, for a specific frequency band (e.g., B48, N48, or N78), the maximum output of the signal output from an antenna may be limited according to various purposes (e.g., protection of a radar work band). Accordingly, even when the first power of the first transmission signal output to the antenna is less than or equal to the maximum transmittable power set for the set specific frequency band, a case in which the first power exceeds the reference of the maximum output limited by the antenna gain may occur. For example, assuming that the maximum output reference for the specific frequency band (e.g., B48, N48, and N78) set by the specific group is 23.0 dBm, and that the maximum transmittable power of the first transmission signal is 23.0 dBm, the antenna gain may be set to 0 dBi or less to meet the maximum output reference of the specific group. According to an embodiment, when the maximum transmittable power of the first transmission signal is 23.0 dBm and the antenna output power of the specific frequency band (e.g., B48, N48, and N78) is 24.0 to 25.0 dBm due to the antenna gain, a situation in which the maximum output reference of the specific group is exceeded may occur. According to an embodiment, in order to meet the maximum output reference (e.g., 23.0 dBm) of the specific group, the maximum transmittable power of the first transmission signal may be decreased by 1 dB to be set to 22.0 dBm. As described above, when the maximum transmittable power of the first transmission signal is decreased, the maximum output reference of the specific group may be met, but not only the transmission power but also the performance of the reception signal may be deteriorated. For example, as performance deterioration of the reception signal occurs, RF performance deterioration such as call drop and throughput (T-put) performance deterioration in a weak electric field may occur.

In the embodiments described below, when the first transmission signal corresponding to the specific frequency band is transmitted, the first transmission signal may be simultaneously transmitted through a plurality of antennas, thereby meeting the maximum output reference for the set specific frequency band without adjusting the matching circuit of the antenna or reducing the maximum transmittable power.

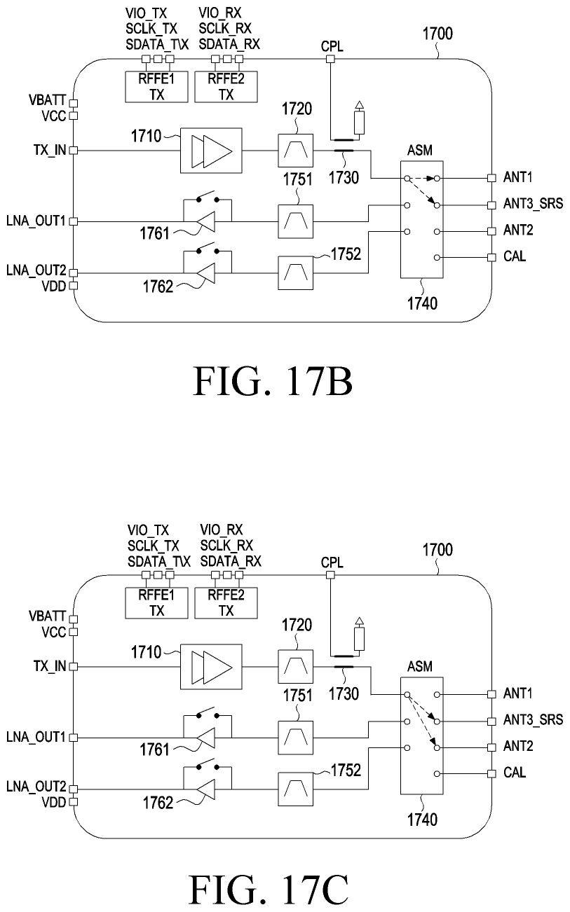

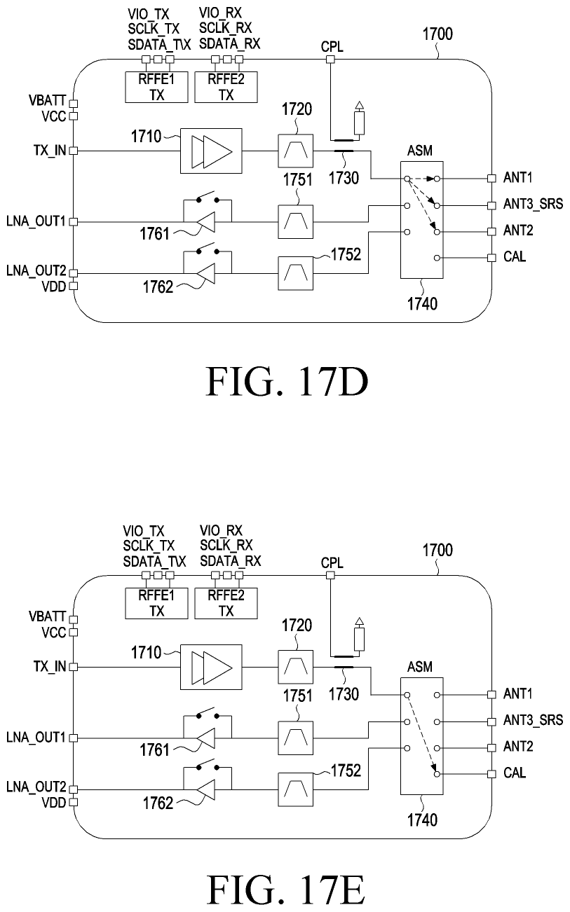

FIGS. 17A, 17B, 17C, 17D, and 17E are circuit diagrams illustrating a detailed circuit of an electronic device according to various embodiments of the disclosure.

Referring to FIGS. 17A, 17B, 17C, 17D, and 17E, according to an embodiment, an RF circuit 1700 may include an amplifier 1710 (e.g., a power amplifier (PA)), band pass filters (BPFs) (e.g., a first BPF 1720, a 2-1th BPF 1751, and a 2-2th BPF 1752), a coupler 1730, a switching circuit 1740 (e.g., a switch box or an antenna switch module (ASM)), and a low noise amplifier (LNA) (e.g., a 2-1th LNA 1761 and a 2-2th LNA 1762). According to an embodiment, the RF circuit 1700 may be referred to as an RFFE, a front end module (FEM), a power amplifier module (PAM), a power amplifier module with integrated duplexer (PAMiD), a LNA PAMiD (LPAMiD), or a front end module with integrated duplexer (FEMid) depending on the function or the component included therein, but is not limited thereto.

Referring to FIGS. 17A, 17B, 17C, 17D, and 17E, the amplifier 1710 and the switching circuit 1740 may be included in one semiconductor chip or integrated circuit constituting the RF circuit 1700. According to an embodiment, the switching circuit 1740 may be configured as a separate module outside the RF circuit 1700. According to an embodiment, the RF circuit 1700 may be configured as a semiconductor chip integrated with the above-described RF IC 1120 or an integrated circuit. For example, the amplifier 1710 and/or the switching circuit 1740 included in the RF circuit 1700 may be configured as a semiconductor chip integrated with the RFIC 1120 or an integrated circuit.

According to an embodiment, the first transmission signal corresponding to the first frequency band (e.g., N77 or N78) output from the RFIC (e.g., the RFIC 1120 of FIG. 11) may be amplified to the first power (e.g., the conduction power or the target power) through the amplifier 1710 of the RF circuit 1700. The first transmission signal amplified by the amplifier 1710 may be band-filtered through the first BPF 1720 and may be input to the switching circuit 1740 through the coupler 1730. According to an embodiment, as illustrated in FIGS. 17A, 17B, 17C, and 17D, the first transmission signal input to the switching circuit 1740 through the coupler 1730 may be simultaneously transmitted through at least two terminals (e.g., two terminals or three terminals) of the first antenna connection terminal ANT1, the second antenna connection terminal ANT2, and the third antenna connection terminal ANT_SRS at the transmission time.

Referring to FIG. 17A, the first transmission signal may be simultaneously transmitted to a second sub antenna (e.g., the second sub antenna 922 of FIG. 9) and a first sub antenna (e.g., the first sub antenna 921 of FIG. 9) at the transmission time. For example, the switching circuit 1740 may simultaneously connect the terminal connected to the coupler 1730 to the first antenna connection terminal ANT1 and the second antenna connection terminal ANT2 at the transmission time of the first transmission signal. The first transmission signal may be simultaneously transmitted to the second sub antenna (e.g., the second sub antenna 922 of FIG. 9) and the first sub antenna (e.g., the first sub antenna 921 of FIG. 9) through the first antenna connection terminal ANT1 and the second antenna connection terminal ANT2 of the switching circuit 1740.

Referring to FIG. 17B, the first transmission signal may be simultaneously transmitted to the second sub antenna (e.g., the second sub antenna 922 of FIG. 9) and the third main antenna (e.g., the third main antenna 913 of FIG. 9), or the second sub antenna (e.g., the second sub antenna 922 of FIG. 9) and the fifth sub antenna (e.g., the fifth sub antenna 925 of FIG. 9) at the transmission time. For example, the switching circuit 1740 may simultaneously connect the terminal connected to the coupler 1730 to the first antenna connection terminal ANT1 and the third antenna connection terminal ANT3_SRS at the transmission time of the first transmission signal. The first transmission signal may be simultaneously transmitted to the second sub antenna (e.g., the second sub antenna 922 of FIG. 9) and the third main antenna (e.g., the third main antenna 913 of FIG. 9) or may be simultaneously transmitted to the second sub antenna (e.g., the second sub antenna 922 of FIG. 9) and the fifth sub antenna (e.g., the fifth sub antenna 925 of FIG. 9) through the first antenna connection terminal ANT1 and the third antenna connection terminal ANT3_SRS of the switching circuit 1740.

Referring to FIG. 17C, the first transmission signal may be simultaneously transmitted to the first sub antenna (e.g., the first sub antenna 921 of FIG. 9) and the third main antenna (e.g., the third main antenna 913 of FIG. 9), or the first sub antenna (e.g., the first sub antenna 921 of FIG. 9) and the fifth sub antenna (e.g., the fifth sub antenna 925 of FIG. 9) at the transmission time. For example, the switching circuit 1740 may simultaneously connect the terminal connected to the coupler 1730 to the second antenna connection terminal ANT2 and the third antenna connection terminal ANT3_SRS at the transmission time of the first transmission signal. The first transmission signal may be simultaneously transmitted to the first sub antenna (e.g., the first sub antenna 921 of FIG. 9) and the third main antenna (e.g., the third main antenna 913 of FIG. 9) or may be simultaneously transmitted to the first sub antenna (e.g., the first sub antenna 921 of FIG. 9) and the fifth sub antenna (e.g., the fifth sub antenna 925 of FIG. 9) through the second antenna connection terminal ANT2 and the third antenna connection terminal ANT3_SRS of the switching circuit 1740.

Referring to FIG. 17D, the first transmission signal may be simultaneously transmitted to the second sub antenna (e.g., the second sub antenna 922 of FIG. 9), the first sub antenna (e.g., the first sub antenna 921 of FIG. 9), the third main antenna (e.g., the third main antenna 913 of FIG. 9), or the second sub antenna (e.g., the second sub antenna 922 of FIG. 9), the first sub antenna (e.g., the first sub antenna 921 of FIG. 9), and the fifth sub antenna (e.g., the fifth sub antenna 925 of FIG. 9) at the transmission time. For example, the switching circuit 1740 may simultaneously connect the terminal connected to the coupler 1730 to the first antenna connection terminal ANT1, the second antenna connection terminal ANT2, and the third antenna connection terminal ANT3_SRS at the transmission time of the first transmission signal. The first transmission signal may be simultaneously transmitted to the second sub antenna (e.g., the second sub antenna 922 of FIG. 9), the first sub antenna (e.g., the first sub antenna 921 of FIG. 9), and the third main antenna (e.g., the third main antenna 913 of FIG. 9), or may be simultaneously transmitted to the second sub antenna (e.g., the second sub antenna 922 of FIG. 9), the first sub antenna (e.g., the first sub antenna 921 of FIG. 9), and the fifth sub antenna (e.g., the fifth sub antenna 925 of FIG. 9) through the first antenna connection terminal ANT1, the second antenna connection terminal ANT2, and the third antenna connection terminal ANT3_SRS of the switching circuit 1740.

According to an embodiment, referring to FIG. 17E, the switching circuit 1740 may connect the terminal connected to the coupler 1730 from which the first transmission signal is output to a CAL terminal. The CAL terminal may be connected to the processor (e.g., the processor 120 or the integrated communication processor 260 of FIG. 2B or FIG. 2C) or the RFIC 1120. The processor (e.g., the processor 120 or the integrated communication processor 260 of FIG. 2B or FIG. 2C) or the RFIC 1120 may measure the power of the first transmission signal from the signal received through the CAL terminal. For example, the RF circuit 1700 may have a different path loss for each manufactured product, and have different characteristics of each component. Accordingly, the processor (e.g., the processor 120 or the integrated communication processor 260 of FIG. 2B or FIG. 2C) or the RFIC 1120 may perform calibration so that the power corresponding to the power control signal is input to the switching circuit 1740 based on the signal received through the CAL terminal. According to an embodiment, the calibration may be performed when the product is manufactured, or may be performed whenever a specific event occurs while the RFIC 1120 is operating or every set period.

According to an embodiment, the switching circuit 1740 may be controlled by a control signal SW_CTRL of a processor (e.g., the processor 120 or the integrated communication processor 260 of FIG. 2B or FIG. 2C). For example, the switching circuit 1740 may be controlled based on a logic table set as shown in Table 3 below.

TABLE 3

| | port |
|---|---|
| SW_CTRL | ANT1 |
| | ANT2 |
| | ANT3_SRS |
| | ANT1 + ANT2 |
| | ANT1 + ANT3_SRS |
| | ANT2 + ANT3_SRS |
| | ANT1 + ANT2 + ANT3_SRS |
| | CAL |

According to an embodiment, referring to Table 3, the first transmission signal corresponding to the first frequency band input to the switching circuit 1740 through the coupler 1730 may be added to Table 2 by the control signal SW_CTRL of the processor (e.g., the processor 120 or the integrated communication processor 260 of FIG. 2B or FIG. 2C) and may be simultaneously transmitted to at least two ports (e.g., two ports or three ports) of ANT1, ANT2, and ANT3_SRS.

According to an embodiment, when the control signal SW_CTRL is a signal corresponding to ANT1+ANT2, the first transmission signal may be simultaneously transmitted to the second sub antenna (e.g., the second sub antenna 922 of FIG. 9) and the first sub antenna (e.g., the first sub antenna 921 of FIG. 9) through the ANT1 port and the ANT2 port. When the control signal SW_CTRL is a signal corresponding to ANT1+ANT3_SRS, the first transmission signal may be simultaneously transmitted to the second sub antenna (e.g., the second sub antenna 922 of FIG. 9) and the third main antenna (e.g., the third main antenna 913 of FIG. 9) or may be simultaneously transmitted to the second sub antenna (e.g., the second sub antenna 922 of FIG. 9) and the fifth sub antenna (e.g., the fifth sub antenna 925 of FIG. 9) through the ANT1 port and the ANT3_SRS port. When the control signal SW_CTRL is a signal corresponding to ANT2+ANT3_SRS, the first transmission signal may be simultaneously transmitted to the first sub antenna (e.g., the first sub antenna 921 of FIG. 9) and the third main antenna (e.g., the third main antenna 913 of FIG. 9) or may be simultaneously transmitted to the first sub antenna (e.g., the first sub antenna 921 of FIG. 9) and the fifth sub antenna (e.g., the fifth sub antenna 925 of FIG. 9) through the ANT2 port and the ANT3_SRS port. When the control signal SW_CTRL is a signal corresponding to ANT1+ANT2+ANT3_SRS, the first transmission signal may be simultaneously transmitted to the second sub antenna (e.g., the second sub antenna 922 of FIG. 9), the first sub antenna (e.g., the first sub antenna 921 of FIG. 9), and the third main antenna (e.g., the third main antenna 913 of FIG. 9) or may be simultaneously transmitted to the second sub antenna (e.g., the second sub antenna 922 of FIG. 9), the first sub antenna (e.g., the first sub antenna 921 of FIG. 9), the fifth sub antenna (e.g., the fifth sub antenna 925 of FIG. 9) through the ANT1 port, the ANT2 port, and the ANT3_SRS port. When the control signal SW_CTRL is a signal corresponding to the CAL, the first transmission signal may be transmitted to the processor (e.g., the processor 120 or the integrated communication processor 260 of FIG. 2B or FIG. 2C) or the RFIC 1120 through the CAL port.

According to an embodiment, the first transmission signal may be simultaneously transmitted through at least two antennas (e.g., two antennas or three antennas), thereby reducing power output through each antenna without deteriorating the performance of the antenna. Even if the amplifier 1710 outputs the first transmission signal with the maximum transmittable power, the first transmission signal may be distributed to and transmitted through a plurality of antennas, and thus the power transferred to each antenna may be decreased. For example, when the first power of the first transmission signal output from the amplifier 1710 is 23 dBm and the first transmission signal is distributed and transferred through two antennas through the switching circuit 1740, 20 dBm of power may be transferred to each antenna. Accordingly, the power radiated from each antenna may meet the maximum output reference (e.g., 23.0 dBm) of a specific frequency band set for each antenna even if an antenna gain is applied at the power of 20 dBm. For example, as described above, assuming that the maximum output reference for a specific frequency band (e.g., B48, N48, and N78) of a specific group is 23.0 dBm, and that the maximum transmittable power of the first transmission signal is 23.0 dBm, the maximum output reference may be met by simultaneously transmitting the first transmission signal through at least two antennas even without decreasing the antenna gain through the matching circuit.

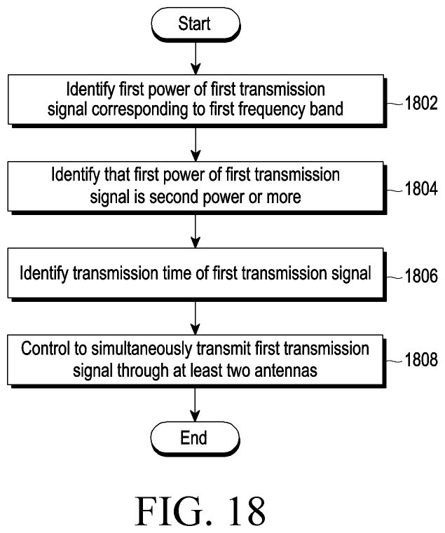

FIG. 18 is a flowchart illustrating a method for operating an electronic device according to an embodiment of the disclosure.

Referring to FIG. 18, according to various embodiments, in operation 1802, the processor (e.g., the processor 120 or the integrated communication processor 260 of FIG. 2B or FIG. 2C) of the electronic device 101 may identify the first power of the first transmission signal corresponding to the first frequency band (e.g., B48, N48, and N78). According to an embodiment, the first power of the first transmission signal may correspond to power measured between the output of the amplifier (e.g., the amplifier 1710 of FIGS. 17A to 17E) and the input of the switching circuit (e.g., the switching circuit 1740 of FIGS. 17A to 17E) in the RF circuit (e.g., the RF circuit 1700 of FIGS. 17A to 17E).

According to an embodiment, the first power of the first transmission signal may be power determined based on Equation 1 described above. For example, the first power may be referred to as conduction power or target power, but is not limited thereto. According to an embodiment, as described above with reference to FIG. 12, the first power may be set not to exceed the maximum transmittable power (Tx Max Power).

According to various embodiments, in operation 1804, the processor (e.g., the processor 120 or the integrated communication processor 260 of FIG. 2B or FIG. 2C) of the electronic device 101 may identify that the first power of the first transmission signal corresponding to the first frequency band (e.g., B48, N48, and N78) is equal to or greater than a set second power. According to an embodiment, the second power may correspond to the maximum power set in relation to the EIRP standard. The second power may be set to a specific value (e.g., 23.0 dBm) or a specific range (e.g., 23.0 dBm to 25.0 dBm). According to an embodiment, in operation 1804, the processor of the electronic device 101 may identify that the first power of the first transmission signal corresponding to the first frequency band (e.g., B48, N48, and N78) is the set maximum power (e.g., 25 dBm).

According to an embodiment, the power of the first transmission signal may be set separately in a plurality of sections. For example, the power of the first transmission signal may be set separately in a low power section, a mid-power section, and a high power or maximum power (max power) section. According to an embodiment, the maximum power section may correspond to a section that violates the EIRP standard. For example, the maximum power section may be set to 23.0 dBm to 25.0 dBm. According to an embodiment, in operation 1804, the processor of the electronic device 101 may identify that the first power of the first transmission signal corresponds to the maximum power section.

According to various embodiments, in operation 1806, the processor (e.g., the processor 120 or the integrated communication processor 260 of FIG. 2B or FIG. 2C) of the electronic device 101 may identify the transmission time of the first transmission signal. According to an embodiment, when the first frequency band operates according to a time division duplexing (TDD) scheme, the transmission time of the first transmission signal may be determined by a transmission/reception pattern received from the network (e.g., the base station). According to an embodiment, the electronic device 101 may receive an RRC reconfiguration message (e.g., RRC reconfiguration message or RRC connection reconfiguration message) from the network. The electronic device 101 may identify a time division-uplink-downlink configuration, as shown in Table 4 below, based on time division-uplink-downlink-configuration information (e.g., tdd-UL-DL-ConfigurationCommon IE) included in the RRC reconfiguration message.

TABLE 4

```
tDD-UL-DL-ConfigCommon
{
  referenceSubcarrierSpacing kHz30,
    pattern 1
    {
      dl-UL-TransmissionPeriodicity  ms2p5,
      nrofDownlinkSlots  3
      nrofDownlinkSymbols  10
      nrofUplinkSlots  1
      nrofUplinkSymbols  2
    pattern2
    }
      {
      dl-UL-TransmissionPeriodicity  ms2p5,
      nrofDownlinkSlots  2
      nrofDownlinkSymbols  10
      nrofUplinkSlots  2
      nrofUplinkSymbols  2
    }
  }
```

The example in Table 4 may be information in the RRC reconfiguration message when the network instructs to alternately use Pattern 1 and Pattern 2. Pattern 1 may indicate that the period is 2.5 ms, the number of slots and the number of symbols corresponding to downlink are 3 slots and 10 symbols, respectively, and the number of slots and the number of symbols corresponding to uplink are 1 slot and 2 symbols, respectively, and in this case, the guard period may be 2 symbols. Pattern 2 may indicate that the period is 2.5 ms, the number of slots and the number of symbols corresponding to downlink are 2 slots and 10 symbols, respectively, and the number of slots and the number of symbols corresponding to uplink are 2 slots and 2 symbols, respectively, and in this case, the guard period may be 2 symbols. Table 5 below shows an example of various patterns of TDD.

TABLE 5

| | | | | |
|---|---|---|---|---|
| D | D | D | D/U | U |

In Table 5 above, slot “D” may mean that all the symbols in the slot are symbols for downlink (e.g., slot format is 0). Slot “U” may mean that all the symbols in the slot are symbols for uplink (e.g., slot format is 1). Slot “D/U” may mean that the symbol for downlink and the symbol for uplink are mixed in the slot (e.g., slot format is a value other than 0 or 1).

According to various embodiments, in operation 1808, the processor (e.g., the processor 120 or the integrated communication processor 260 of FIG. 2B or FIG. 2C) of the electronic device 101 may perform control so that the first transmission signal is simultaneously transmitted through at least two antennas (e.g., two antennas or three antennas) at the identified transmission time of the first transmission signal, based on identifying that the first power of the first transmission signal corresponding to the first frequency band (e.g., B48, N48, and N78) is equal to or greater than the set second power. According to an embodiment, as described above with reference to FIGS. 17A to 17E, the processor of the electronic device 101 may control the switch circuit (e.g., the switch circuit 1740 of FIGS. 17A to 17E) by the control signal SW_CTRL as shown in Table 3, so that the first transmission signal is simultaneously transmitted to at least two ports (e.g., two ports or three ports) of ANT1, ANT2, and ANT3_SRS.

According to an embodiment, the first transmission signal may be simultaneously transmitted through at least two antennas, thereby reducing power output through the antennas without deteriorating the performance of the antenna. For example, as described above, even if the amplifier (e.g., the amplifier 1710 of FIGS. 17A to 17E) included in the RF circuit (e.g., the RF circuit 1700 of FIGS. 17A to 17E) outputs the first transmission signal with the maximum transmittable power, the first transmission signal may be distributed into the plurality of paths and transmitted through the plurality of antennas, so that the power transferred to one antenna may be decreased. For example, even if the electronic device 101 does not decrease the antenna gain through the matching circuit, the electronic device 101 may simultaneously transmit the first transmission signal through at least two antennas, thereby meeting the maximum output reference set in relation to the EIRP standard.

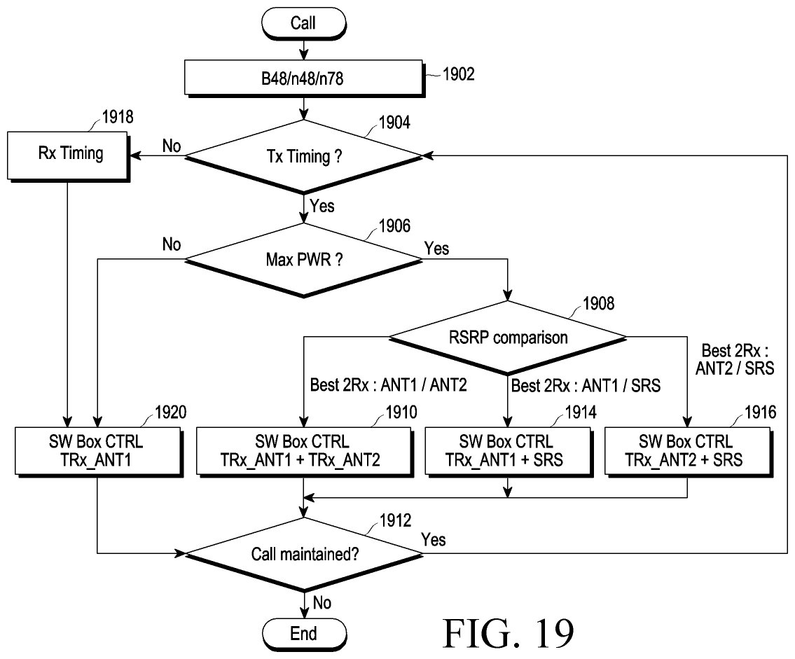

FIG. 19 is a flowchart illustrating a method for operating an electronic device according to an embodiment of the disclosure.

Referring to FIG. 19, according to various embodiments, in operation 1902, the processor (e.g., the processor 120 or the integrated communication processor 260 of FIG. 2B or FIG. 2C) of the electronic device 101 may transmit and receive a signal in a first frequency band (e.g., B48, N48, or N78) while a call is connected. According to an embodiment, the embodiment of FIG. 19 illustrates a state in which a call is connected, but may be performed in the same or similar manner in an RRC connected state in which a call is not connected.

According to various embodiments, in operation 1904, the processor (e.g., the processor 120 or the integrated communication processor 260 of FIG. 2B or FIG. 2C) of the electronic device 101 may identify the transmission time of the first transmission signal corresponding to the first frequency band (e.g., B48, N48, and N78). According to an embodiment, when it is not at the transmission time (No in 1904) in operation 1904, but it is at the reception time in operation 1918, the processor of the electronic device 101 may transmit the control signal SW_CTRL to the switching circuit (e.g., the switching circuit 1740 of FIGS. 17A to 17E) (e.g., the switching box or ASM) in operation 1920, so that the first antenna connection terminal ANT1 is connected to the reception circuit (e.g., the 2-1th BPF 751 or the 2-2th BPF 1752 of FIGS. 17A to 17E).

According to various embodiments, in operation 1904, when it is at the transmission time (Yes in 1904), the processor of the electronic device 101 may identify whether the first power of the first transmission signal is the set maximum power (Max Power) in operation 1906. For example, the maximum power may correspond to the maximum power set in relation to the EIRP standard. As a result of the identification, when the first power of the first transmission signal is not the maximum power (No in operation 1906) (e.g., when the first power is less than the maximum power), the processor of the electronic device 101 may transmit the control signal SW_CTRL to the switching circuit (e.g., the switching circuit 1740 of FIGS. 17A to 17E) (e.g., the switching box or ASM) in operation 1920, so that the first antenna connection terminal ANT1 is connected to the output of the amplifier (e.g., the amplifier 1710 of FIGS. 17A to 17E). For example, in operation 1920, the processor of the electronic device 101 may transmit the control signal SW_CTRL to the switching circuit (e.g., the switching circuit 1740 of FIGS. 17A to 17E) (e.g., the switching box or the ASM) so that the first transmission signal of first power is transmitted to the second sub antenna (e.g., the second sub antenna 922 of FIG. 9) through the first antenna connection terminal ANT1.

According to various embodiments, operation 1906 may be performed before operation 1904. For example, the processor of the electronic device 101 may be configured to identify the transmission time after identifying whether the first power of the first transmission signal is the set maximum power.

According to various embodiments, when the first power of the first transmission signal is the maximum power in operation 1906 (Yes in operation 1906), the processor of the electronic device 101 may identify the reference signals received power (RSRP) of the signal received at each antenna port (e.g., ANT1, ANT2, and ANT3_SRS) in operation 1908. According to an embodiment, as a result of the identification, the processor of the electronic device 101 may control the switching circuit 1740 (e.g., a switching box or an ASM) to output the first transmission signal through the two antenna ports receiving the signal having the highest RSRP.

According to various embodiments, when the RSRP of the signal received through the first antenna connection terminal ANT1 and the second antenna connection terminal ANT2 is relatively higher, in operation 1910, the processor of the electronic device 101 may input the control signal SW_CTRL corresponding to ANT1+ANT2 to the switching circuit 1740 (e.g., the switching box or the ASM) so that the first transmission signal is simultaneously transmitted to the second sub antenna (e.g., the second sub antenna 922 of FIG. 9) and the first sub antenna (e.g., the first sub antenna 921 of FIG. 9) through the ANT1 port and the ANT2 port.

According to various embodiments, when the RSRP of the signal received through the first antenna connection terminal ANT1 and the third antenna connection terminal ANT3_SRS is relatively higher, in operation 1914, the processor of the electronic device 101 may input the control signal SW_CTRL corresponding to ANT1+ANT3_SRS to the switching circuit 1740 (e.g., the switching box or ASM), so that the first transmission signal is simultaneously input to the second sub antenna (e.g., the second sub antenna 922 of FIG. 9) and the third main antenna (e.g., the third main antenna 913 of FIG. 9) through the ANT1 port and the ANT3_SRS port or is simultaneously transmitted to the second sub antenna (e.g., the second sub antenna 922 of FIG. 9) and the fifth sub antenna (e.g., the fifth sub antenna 925 of FIG. 9).

According to various embodiments, when the RSRP of the signal received through the second antenna connection terminal ANT2 and the third antenna connection terminal ANT3_SRS is relatively higher, in operation 1916, the processor of the electronic device 101 may input the control signal SW_CTRL corresponding to ANT2+ANT3_SRS to the switching circuit 1740 (e.g., the switching box or ASM) so that the first transmission signal is simultaneously transmitted to the first sub antenna (e.g., the first sub antenna 921 of FIG. 9) and the third main antenna (e.g., the third main antenna 913 of FIG. 9) through the ANT2 port and the ANT3_SRS port or is simultaneously transmitted to the first sub antenna (e.g., the first sub antenna 921 of FIG. 9) or the fifth sub antenna (e.g., the fifth sub antenna 925 of FIG. 9).

According to various embodiments, in operation 1912, the processor (e.g., the processor 120 or the integrated communication processor 260 of FIG. 2B or FIG. 2C) of the electronic device 101 may repeat the above-described procedure while the call is maintained (Yes in operation 1912). When the call is terminated (No in operation 1912), the processor of the electronic device 101 may terminate the above-described procedure.

As described above with reference to FIGS. 18 and 19, according to various embodiments, for a specific frequency band (e.g., the first frequency band) in which power is limited in relation to EIRP, the performance of the reception signal may be maintained by simultaneously transmitting the first transmission signal using a plurality of antennas through multiple paths only at the transmission time, and optimal antenna performance may be provided in low power, mid power, and high power sections. Further, the EIRP may be enhanced and the null state of the antenna beam may be overcome by distributing the first transmission signal to multiple antenna paths in the section in which the first transmission signal is at the maximum transmittable power. It is also possible to address deterioration of antenna performance when the electronic device 101 is gripped.

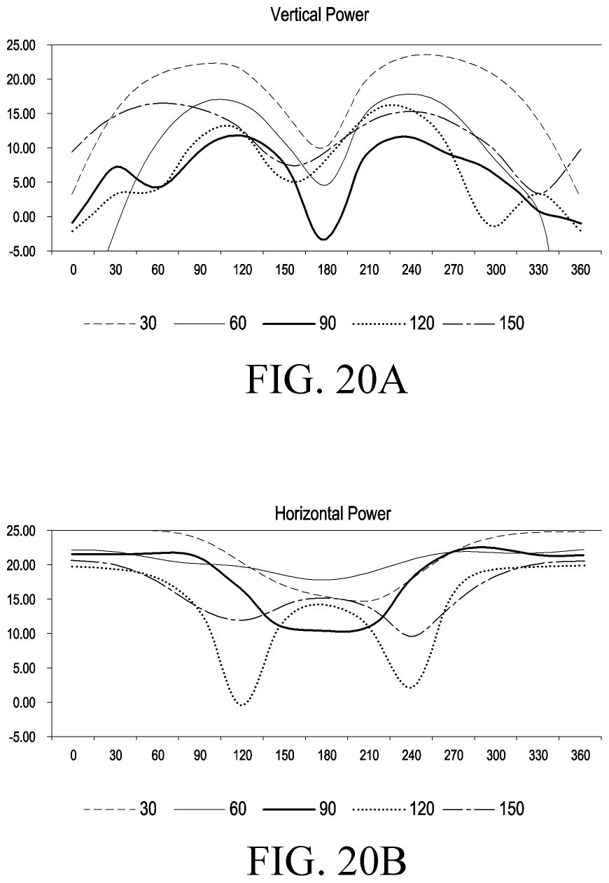

FIGS. 20A, 21A, and 22A are graphs illustrating vertical output of an antenna, according to various embodiments of the disclosure.

FIGS. 20B, 21B, and 22B are graphs illustrating horizontal output of an antenna, according to various embodiments of the disclosure.

According to various embodiments, referring to FIGS. 20A and 20B, when the first transmission signal is transmitted through only the first antenna connection terminal ANT1, the output of the antenna may be identified. For example, FIGS. 20A and 20B illustrate vertical and horizontal outputs at 30 degrees, 60 degrees, 90 degrees, 120 degrees, and 150 degrees when the first transmission signal is transmitted through only the first antenna connection terminal ANT1.

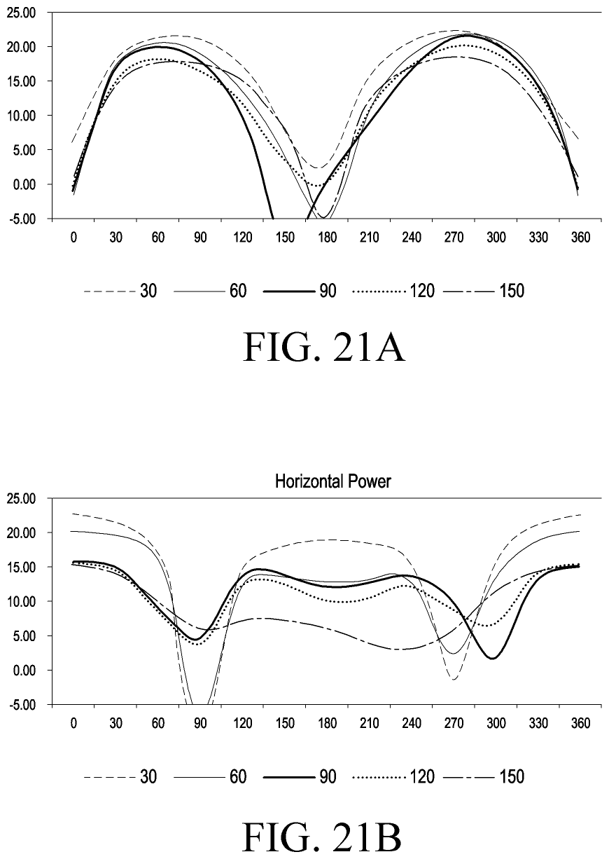

According to various embodiments, referring to FIGS. 21A and 21B, the output of the antenna when the first transmission signal is transmitted through only the second antenna connection terminal ANT2 may be identified. For example, FIGS. 21A and 21B illustrate vertical and horizontal outputs at 30 degrees, 60 degrees, 90 degrees, 120 degrees, and 150 degrees when the first transmission signal is transmitted through only the second antenna connection terminal ANT2.

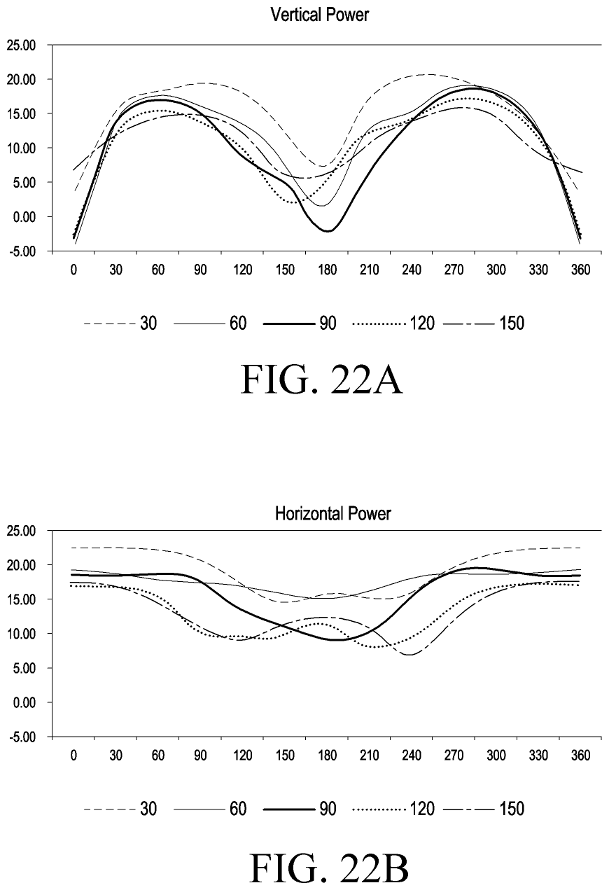

According to various embodiments, referring to FIGS. 22A and 22B, the output of the antenna when the first transmission signal is simultaneously transmitted through the first antenna connection terminal ANT1 and the second antenna connection terminal ANT2 may be identified. For example, FIGS. 22A and 22B illustrate vertical and horizontal outputs at 30 degrees, 60 degrees, 90 degrees, 120 degrees, and 150 degrees when the first transmission signal is simultaneously transmitted through the first antenna connection terminal ANT1 and the second antenna connection terminal ANT2.

According to various embodiments, as illustrated in FIGS. 22A and 22B, when the first transmission signal is simultaneously transmitted through the first antenna connection terminal ANT1 and the second antenna connection terminal ANT2, it may be identified that a null point is enhanced. For example, when the first transmission signal is distributed through the first antenna connection terminal ANT1 and the second antenna connection terminal ANT2 and transmitted simultaneously, it may be identified that 22.27 dBm is measured at 25.27 degrees which is the angle corresponding to the peak power, meeting the EIRP standard.

According to various embodiments, as illustrated in FIG. 22A, when the first transmission signal is simultaneously transmitted through the first antenna connection terminal ANT1 and the second antenna connection terminal ANT2, it may be identified that the vertical output in the 30-degree to 60-degree section and the 60-degree to 120-degree section is enhanced by 7 to 13 dB compared to when the first transmission signal is transmitted through one antenna connection terminal. Further, as illustrated in FIG. 22A, when the first transmission signal is simultaneously transmitted through the first antenna connection terminal ANT1 and the second antenna connection terminal ANT2, it may be identified that the vertical output in the 300-degree to 330-degree section and the 60-degree to 120-degree section is enhanced by 9 to 18 dB compared to when the first transmission signal is transmitted through one antenna connection terminal. According to an embodiment, the electronic device 101 may enhance transmission/reception performance by about 2 dB by transmitting the first transmission power through an optimal single antenna in a low-power or mid-power section. By enhancing the RF performance, it is possible to provide advantages in MCS allocation and to enhance throughput.

According to various embodiments, an electronic device may comprise a plurality of antennas. The electronic device according to an embodiment may comprise a radio frequency (RF) circuit including an amplifier configured to amplify an RF signal and a switching circuit configured to selectively connect the amplifier to at least one antenna among the plurality of antennas. The electronic device according to an embodiment may comprise a processor electrically connected to the RF circuit. The electronic device according to an embodiment may comprise memory storing instructions. The instructions according to an embodiment, when executed by the processor individually or collectively, may cause the electronic device to identify a first power of a first transmission signal corresponding to a first frequency band, transmitted through the RF circuit 1700. The instructions according to an embodiment, when executed by the processor individually or collectively, may cause the electronic device to, based on identifying that the first power is greater than or equal to a set second power, control the switching circuit so that the first transmission signal is simultaneously transmitted through at least two antennas among the plurality of antennas at a transmission time of the first transmission signal.

According to an embodiment, the instructions, when executed by the processor individually or collectively, may cause the electronic device to, during connection of a call, identifying the first power of the first transmission signal corresponding to the first frequency band. According to an embodiment, the instructions, when executed by the processor individually or collectively, may cause the electronic device to, based on identifying that the first power of the first transmission signal corresponds to a set maximum power, control the switching circuit so that the first transmission signal is simultaneously transmitted through at least two antennas among a first transmission antenna, a second transmission antenna, and a third antenna for transmitting a sounding reference signal (SRS), wherein the first transmission antenna and the second transmission antenna are connectable to the RF circuit.

According to an embodiment, the instructions, when executed by the processor individually or collectively, may cause the electronic device to, based on identifying that the first power of the first transmission signal corresponds to a set maximum power, control the switching circuit so that the first transmission signal is simultaneously transmitted through at least two antennas with a greatest received signal strength among a first transmission antenna, a second transmission antenna, and a third antenna for transmitting a sounding reference signal (SRS), wherein the first transmission antenna and the second transmission antenna are connectable to the RF circuit.

According to an embodiment, the first power of the first transmission signal may correspond to a power measured between an output of the amplifier and an input of the switching circuit.

According to an embodiment, the second power may correspond to the maximum power set in relation to the effective isotropic radiated power (EIRP) standard.

According to an embodiment, the instructions, when executed by the processor individually or collectively, may cause the electronic device to control the switching circuit so that the first transmission signal is simultaneously transmitted through the first transmission antenna, and the third antenna for transmitting the sounding reference signal (SRS) among the plurality of antennas.

According to an embodiment, the instructions, when executed by the processor individually or collectively, may cause the electronic device to control the switching circuit so that the first transmission signal is simultaneously transmitted through the first transmission antenna, the second transmission antenna, and the third antenna for transmitting the sounding reference signal (SRS) among the plurality of antennas.

According to an embodiment, the switching circuit may include a port for measuring the first power of the first transmission signal.

According to an embodiment, the instructions, when executed by the processor individually or collectively, may cause the electronic device to control the switching circuit by a set value stored in a registry.

According to an embodiment, the instructions, when executed by the processor individually or collectively, may cause the electronic device to control the switching circuit so that a second transmission signal corresponding to a second frequency band is transmitted through an antenna among the plurality of antennas at a transmission time of the second transmission signal.

According to various embodiments, a method for operating an electronic device including a plurality of antennas, a radio frequency circuit including an amplifier and a switching circuit, and a processor may comprise identifying a first power of a first transmission signal corresponding to a first frequency band, transmitted through the RF circuit. The method for operating the electronic device according to an embodiment may comprise, based on identifying that the first power is greater than or equal to a set second power, controlling the switching circuit included in the RF circuit so that the first transmission signal is simultaneously transmitted through at least two antennas among the plurality of antennas at a transmission time of the first transmission signal.

According to an embodiment, the method may further comprise, during connection of a call, identifying the first power of the first transmission signal corresponding to the first frequency band. According to an embodiment, the method may further comprise, based on identifying that the first power of the first transmission signal corresponds to a set maximum power, controlling the switching circuit so that the first transmission signal is simultaneously transmitted through at least two antennas among a first transmission antenna, a second transmission antenna, and a third antenna for transmitting a sounding reference signal (SRS), wherein the first transmission antenna and the second transmission antenna are connectable to the RF circuit.

According to an embodiment, the method may further comprise, based on identifying that the first power of the first transmission signal corresponds to a set maximum power, controlling the switching circuit so that the first transmission signal is simultaneously transmitted through at least two antennas with a greatest received signal strength among a first transmission antenna, a second transmission antenna, and a third antenna for transmitting a sounding reference signal (SRS), wherein the first transmission antenna and the second transmission antenna are connectable to the RF circuit.

According to an embodiment, the first power of the first transmission signal may correspond to a power measured between an output of the amplifier and an input of the switching circuit.

According to an embodiment, the second power may correspond to the maximum power set in relation to the effective isotropic radiated power (EIRP) standard.

According to an embodiment, the method may further comprise controlling the switching circuit so that the first transmission signal is simultaneously transmitted through the first transmission antenna, and the third antenna for transmitting the sounding reference signal (SRS) among the plurality of antennas.

According to an embodiment, the method may further comprise controlling the switching circuit so that the first transmission signal is simultaneously transmitted through the first transmission antenna, the second transmission antenna, and the third antenna for transmitting the sounding reference signal (SRS) among the plurality of antennas.

According to an embodiment, the method may further comprise controlling the switching circuit so that a second transmission signal corresponding to a second frequency band is transmitted through an antenna among the plurality of antennas at a transmission time of the second transmission signal.

According to various embodiments, an electronic device may comprise a processor. The electronic device according to an embodiment may comprise memory storing instructions. The instructions according to an embodiment, when executed by the processor, may enable the electronic device to: identify a first power of a first transmission signal corresponding to a first frequency band. The instructions according to an embodiment, when executed by the processor, may cause the electronic device to, based on identifying that the first power of the first transmission signal is greater than or equal to a set second power, simultaneously transmit the first transmission signal through at least two antennas among a plurality of antennas at a transmission time of the first transmission signal.

According to various embodiments, in a storage medium storing at least one computer-readable instruction, the at least one instruction, when executed by a processor of an electronic device, may enable the electronic device to perform at least one operation. The at least one operation according to an embodiment may comprise, during connection of a call, identifying a first power of a first transmission signal corresponding to a first frequency band. The at least one operation according to an embodiment may comprise, based on identifying that the first power of the first transmission signal is greater than or equal to a set second power, simultaneously transmitting the first transmission signal through at least two antennas among a plurality of antennas at a transmission time of the first transmission signal.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a plurality of antennas;
a radio frequency (RF) circuit including an amplifier configured to amplify an RF signal and a switching circuit configured to selectively connect the amplifier to at least one antenna among the plurality of antennas;
memory storing one or more computer programs; and
one or more processors electrically connected to the RF circuit and the memory,
wherein the one or more computer programs include computer-executable instructions that, when executed by the one or more processors individually or collectively, cause the electronic device to:
identify a first power of a first transmission signal corresponding to a first frequency band, transmitted through the RF circuit, and
based on identifying that the first power is greater than or equal to a set second power, control the switching circuit so that the first transmission signal is simultaneously transmitted through at least two antennas among the plurality of antennas at a transmission time of the first transmission signal.

2. The electronic device of claim 1, wherein the one or more computer programs further include computer-executable instructions, when executed by the one or more processors individually or collectively, cause the electronic device to:
during connection of a call, identify the first power of the first transmission signal corresponding to the first frequency band; and
based on identifying that the first power of the first transmission signal corresponds to a set maximum power, control the switching circuit so that the first transmission signal is simultaneously transmitted through at least two antennas among a first transmission antenna, a second transmission antenna, and a third antenna for transmitting a sounding reference signal (SRS), wherein the first transmission antenna and the second transmission antenna are connectable to the RF circuit.

3. The electronic device of claim 1, wherein the one or more computer programs further include computer-executable instructions, when executed by the one or more processors individually or collectively, cause the electronic device to:
based on identifying that the first power of the first transmission signal corresponds to a set maximum power, control the switching circuit so that the first transmission signal is simultaneously transmitted through at least two antennas with a greatest received signal strength among a first transmission antenna, a second transmission antenna, and a third antenna for transmitting a sounding reference signal (SRS), wherein the first transmission antenna and the second transmission antenna are connectable to the RF circuit.

4. The electronic device of claim 1, wherein the first power of the first transmission signal corresponds to a power measured between an output of the amplifier and an input of the switching circuit.

5. The electronic device of claim 1, wherein the second power corresponds to a maximum power set in relation to an effective isotropic radiated power (EIRP) standard.

6. The electronic device of claim 2, wherein the one or more computer programs further include computer-executable instructions, when executed by the one or more processors individually or collectively, cause the electronic device to control the switching circuit so that the first transmission signal is simultaneously transmitted through the first transmission antenna, and the third antenna for transmitting the sounding reference signal (SRS) among the plurality of antennas.

7. The electronic device of claim 2, wherein the one or more computer programs further include computer-executable instructions, when executed by the one or more processors individually or collectively, cause the electronic device to control the switching circuit so that the first transmission signal is simultaneously transmitted through the first transmission antenna, the second transmission antenna, and the third antenna for transmitting the sounding reference signal (SRS) among the plurality of antennas.

8. The electronic device of claim 1, wherein the switching circuit includes a port for measuring the first power of the first transmission signal.

9. The electronic device of claim 1, wherein the one or more computer programs further include computer-executable instructions, when executed by the one or more processors individually or collectively, cause the electronic device to control the switching circuit by a set value stored in a registry.

10. The electronic device of claim 1, wherein the one or more computer programs further include computer-executable instructions, when executed by the one or more processors individually or collectively, cause the electronic device to control the switching circuit so that a second transmission signal corresponding to a second frequency band is transmitted through an antenna among the plurality of antennas at a transmission time of the second transmission signal.

11. A method for operating an electronic device including a plurality of antennas, a radio frequency (RF) circuit including an amplifier and a switching circuit, and a processor, the method comprising:
identifying a first power of a first transmission signal corresponding to a first frequency band, transmitted through the RF circuit; and
based on identifying that the first power is greater than or equal to a set second power, controlling the switching circuit included in the RF circuit so that the first transmission signal is simultaneously transmitted through at least two antennas among the plurality of antennas at a transmission time of the first transmission signal.

12. The method of claim 11, further comprising:
during connection of a call, identifying the first power of the first transmission signal corresponding to the first frequency band; and
based on identifying that the first power of the first transmission signal corresponds to a set maximum power, controlling the switching circuit so that the first transmission signal is simultaneously transmitted through at least two antennas among a first transmission antenna, a second transmission antenna, and a third antenna for transmitting a sounding reference signal (SRS), wherein the first transmission antenna and the second transmission antenna are connectable to the RF circuit.

13. The method of claim 11, further comprising:
based on identifying that the first power of the first transmission signal corresponds to a set maximum power, controlling the switching circuit so that the first transmission signal is simultaneously transmitted through at least two antennas with a greatest received signal strength among a first transmission antenna, a second transmission antenna, and a third antenna for transmitting a sounding reference signal (SRS), wherein the first transmission antenna and the second transmission antenna are connectable to the RF circuit.

14. The method of claim 11, wherein the first power of the first transmission signal corresponds to a power measured between an output of the amplifier and an input of the switching circuit.

15. The method of claim 11, wherein the second power corresponds to a maximum power set in relation to an effective isotropic radiated power (EIRP) standard.

16. The method of claim 12, further comprising:
controlling the switching circuit so that the first transmission signal is simultaneously transmitted through the first transmission antenna, and the third antenna for transmitting the sounding reference signal (SRS) among the plurality of antennas.

17. The method of claim 12, wherein the set maximum power is set based on at least one of a maximum transmittable power received from a communication network, a maximum transmittable power for each transmission path set by the electronic device, or a specific absorption rate (SAR) event maximum transmittable power set corresponding to the SAR event considering a SAR backoff, and
wherein the first power of the first transmission signal is changed according to a channel state in real time.

18. An electronic device, comprising:
memory including one or more storage media and storing instructions; and
one or more processors communicatively coupled to the memory,
wherein the instructions, when executed by the one or more processors individually or collectively, cause the electronic device to:
identify a first power of a first transmission signal corresponding to a first frequency band, and
based on identifying that the first power of the first transmission signal is greater than or equal to a set second power, simultaneously transmit the first transmission signal through at least two antennas among a plurality of antennas at a transmission time of the first transmission signal.

19. One or more non-transitory computer-readable storage media storing one or more computer programs including computer-executable instructions that, when executed by one or more processors of an electronic device individually or collectively, cause the electronic device to perform operations, the operations comprising:
identifying a first power of a first transmission signal corresponding to a first frequency band; and
based on identifying that the first power of the first transmission signal is greater than or equal to a set second power, simultaneously transmitting the first transmission signal through at least two antennas among a plurality of antennas at a transmission time of the first transmission signal.

20. The one or more non-transitory computer-readable storage media of claim 19, the operations further comprising:
during connection of a call, identifying the first power of the first transmission signal corresponding to the first frequency band; and
based on identifying that the first power of the first transmission signal corresponds to a set maximum power, controlling a switching circuit so that the first transmission signal is simultaneously transmitted through at least two antennas among a first transmission antenna, a second transmission antenna, and a third antenna for transmitting a sounding reference signal (SRS), wherein the first transmission antenna and the second transmission antenna are connectable to an RF circuit.
